(19) United States
(12) Patent Application Publication
(10) Pub. No.: US 2026/0320571 A1
(43) Pub. Date: Oct. 15, 2026

(54) SYSTEM FOR RANDOMIZED MEDIA DATA EXTRACTION AND DISPLAY

(71) Applicant: HPVC, LLC, Bradenton, FL (US)

(72) Inventor: Howard PANES, Bradenton, FL (US)

(73) Assignee: HPVC, LLC, Bradenton, FL (US)

(21) Appl. No.: 19/718,117

(22) Filed: Jun. 24, 2026

Related U.S. Application Data
(63) Continuation-in-part of application No. 17/504,442, filed on Oct. 18, 2021.

(51) Int. Cl. G06Q 20/06

(52) U.S. Cl. CPC G06Q 20/065

(57) ABSTRACT

Embodiments described herein are related to identifying and extracting media data from on-chain blocks for hosting and executing randomized event sessions. A computer receives a plurality of block identifiers of a plurality of on-chain blocks from one or more user devices of one or more possessor-users. For each on-chain block, the computer extracts media data based on a media type determined for the on-chain block. The computer generates a graphical user interface having the media data associated with a randomization event session for display at one or more session user devices according to the media type. The computer receives a request via the graphical user interface to execute a randomization algorithm, executes the randomization algorithm to identify one or more block identifiers corresponding to one or more on-chain blocks, and updates the graphical user interface to display the media data of the identified on-chain blocks.

### CROSS-REFERENCE TO RELATED APPLICATIONS

This application is a continuation-in-part of U.S. patent application Ser. No. 17/504,442, filed Oct. 18, 2021, the content of which is incorporated by reference in its entirety.

### TECHNICAL FIELD

This application generally relates to entries of distributed ledgers, such as on-chain blocks of blockchains; and, more particularly, to systems and methods for executing randomized event sessions using blockchain technology and on-chain blocks, such as non-fungible tokens (NFTs), having unique media data that is extracted and included into event state, event operations, and user interface elements.

### BACKGROUND

Distributed ledger technology enables the creation and management of entries as on-chain blocks (e.g., tokens, NFTs) in distributed ledgers (e.g., blockchains). The entries may record and represent on-chain blocks or transactions across multiple computing nodes participating in the distributed ledger, where certain on-chain blocks can include or reference digital media data and can be associated with unique identifiers that distinguish those entries from other entries on the ledger. Recent developments in blockchain technology have enabled owners of digital media to claim ownership of the digital media. For example, a graphic designer, an artist, a video editor, a content creator, or a programmer can create media data such as image data, video data, audio data, application data, or any combination of them, and generate entries of a distributed ledger, such as on-chain blocks (e.g., NFTs, tokens), containing or associated with the media data. Each on-chain block may include a unique token identifier that uniquely identifies a particular on-chain block and renders the particular on-chain block as non-fungible and non-interchangeable. The non-fungible nature of the on-chain block allows an owner of the on-chain block to assert ownership interest in the media. For example, an owner of an on-chain block may sell the on-chain block to another person or trade the on-chain block with another person for a different on-chain block. While sales or trades of on-chain blocks are example usages of on-chain blocks, other usages or implementations of on-chain blocks remain unexplored.

An emerging example of implementing blockchain technologies includes various types of digital gaming. Computing systems that host interactive sessions involving randomized outcomes, such as gaming or gambling platforms, typically rely on locally stored or centrally managed media assets and employ server-side or client-side algorithms to generate random results, determine session outcomes, and calculate corresponding payouts to participants. However, conventional randomized event platforms lack technical mechanisms for dynamically extracting and incorporating media data from distributed blockchain entries into session interfaces, for programmatically adjusting event configuration parameters based on attributes derived from on-chain or off-chain valuation data associated with those entries, and for executing on-chain programs that automatically allocate fractional award values to multiple distributed addresses associated with different participants based on session outcomes, thereby limiting the ability of such platforms to leverage blockchain-verified digital assets within randomized event architectures.

Conventional gaming systems, such as slot machines and roulette wheels, utilize locally stored or server-hosted media assets with predetermined visual elements. These conventional systems present technical limitations when attempting to incorporate dynamically owned digital assets, such as on-chain blocks (e.g., NFTs), into real-time gameplay displays. For example, when media data is stored on a blockchain or referenced via on-chain pointers, technical challenges arise in (i) retrieving media data from distributed ledger nodes, which may have varying response latencies; (ii) parsing blockchain data structures to extract embedded media or resolve pointers to off-chain storage locations; and (iii) converting blockchain-native data formats into display-ready formats suitable for real-time rendering on gaming interfaces.

Additionally, media data associated with on-chain blocks may be stored in heterogeneous formats and locations. For instance, media data may be directly embedded on-chain within the block itself, referenced via decentralized storage protocols, such as the InterPlanetary File System (IPFS) protocols, or linked to centralized storage servers via uniform resource locators (URLs). Each storage approach requires different retrieval mechanisms and decoding processes to obtain the underlying media data.

Furthermore, generating a user interface that dynamically adapts to present diverse media types (e.g., static images, animated images, video sequences, or audio content) within a consistent gaming experience presents additional technical complexity. Unlike static gaming assets where the media type is predetermined during system design, media types associated with on-chain blocks are often unknown in advance and must be determined at runtime based on the characteristics of the retrieved data.

Conventional gaming display systems also lack mechanisms for synchronizing randomization algorithm outputs with the presentation of blockchain-sourced visual elements. In a gaming context where randomization determines which NFT media to display as a winning outcome, the display system must accurately reflect the blockchain-verified random selection. Failure to properly synchronize the randomization result with the user interface presentation could result in inconsistencies between the distributed ledger state and the visual output presented to the user.

These technical challenges are further compounded in online gambling environments where multiple players participate simultaneously over network connections. Online multiplayer gaming systems must coordinate randomization events across geographically distributed participants, each of whom may be accessing the gaming session through different user devices with varying network latencies and display capabilities. Ensuring that all participants in a multiplayer gambling session observe consistent and synchronized game states, including the same media elements and randomization outcomes, requires additional coordination mechanisms beyond those needed for single-player gaming systems.

In online gambling platforms hosting multiplayer gaming sessions, the host system must manage concurrent connections from multiple user devices, each potentially contributing on-chain blocks to a shared gaming pool or wagering on outcomes involving on-chain blocks contributed by other participants. The technical complexity of extracting, rendering, and displaying the media data from the on-chain blocks in real time is multiplied when the system must perform these operations for numerous participants simultaneously while maintaining game state consistency across all connected devices.

Furthermore, online multiplayer gambling systems present unique challenges for award distribution when randomization outcomes affect multiple participants. For example, in a multiplayer slot tournament or competitive roulette session, the system must determine and distribute awards not only to winning players but also to the owners of on-chain blocks whose media was randomly selected or contributed to the winning outcome, all while multiple gaming sessions may be occurring concurrently across the platform.

Accordingly, there exists a need for improved systems and methods that address these technical challenges by enabling the extraction of media data from on-chain blocks stored in diverse formats and locations, the dynamic generation of gaming user interfaces configured with the extracted media, the synchronized updating of such interfaces based on randomization algorithm outputs, and the coordination of multiplayer online gambling sessions involving multiple concurrent participants and block contributors or owners.

### SUMMARY

Embodiments described herein may address various shortcomings in existing technologies and approaches, and may provide any number of additional or alternative improvements and benefits over conventional technologies. Distributed ledger technologies can store or reference digital media data within discrete data entries, where each entry can include a unique identifier that distinguishes the entry from other entries on the ledger. Computing systems that host interactive sessions involving randomized outcomes can execute randomization algorithms to generate random or pseudo-random results and can determine session outcomes based on the generated results. Conventional randomized event platforms rely on locally stored or centrally managed media assets with predetermined visual elements for presentation in session interfaces. The conventional platforms lack technical mechanisms for dynamically retrieving media data from distributed ledger entries that may store or reference media in heterogeneous formats and locations, including on-chain embedded media, decentralized storage protocol references, and centralized storage server links. Each storage approach requires different retrieval and decoding processes to obtain the underlying media data, and the media type associated with each ledger entry is often unknown until runtime. Conventional gaming display systems do not provide mechanisms for synchronizing randomization algorithm outputs with the presentation of ledger-sourced visual elements, which can result in inconsistencies between the distributed ledger state and the visual output presented to users. Conventional systems do not provide a programmatic mechanism for adjusting event configuration parameters based on attributes derived from on-chain or off-chain valuation data associated with ledger entries, nor do conventional systems provide a mechanism for executing on-chain programs that automatically allocate fractional award values to multiple distributed addresses associated with different participants based on session outcomes.

The embodiments described herein provide systems and methods for extracting media data from on-chain blocks of a distributed ledger and incorporating the extracted media data into randomized event sessions executed by a host computing device. The techniques described herein can employ an event host device that receives block identifiers corresponding to blocks of a distributed ledger from one or more user devices, accesses the blocks via a blockchain control system using the block identifiers, and obtains media data either directly from the blocks or from storage locations referenced by identifiers, addresses, or pointers in the blocks. The event host device can determine a storage format type for each block and execute a corresponding retrieval mechanism to extract the media data based on the determined storage format type. The event host device can assign the obtained media data to corresponding event positions of a randomized event session, execute a randomization algorithm to select one or more blocks based on randomly generated values, and update a user interface in synchronization with the randomization output such that displayed visual elements accurately reflect the ledger-verified random selection. The event host device can determine award values for session participants and for owners of the selected blocks by executing an on-chain executable program that computes a first award value and a second award value based upon a fraction of the first award value. The event host device can transmit result notifications and provide instructions that cause updates to user databases, thereby enabling account information for a player-user, a possessor-user, or both to be updated according to corresponding result values. The techniques described herein can generate user interfaces that dynamically adapt at runtime to present diverse media types, including static images, animated images, video sequences, and audio content, without requiring advance knowledge of the media formats prior to session execution.

Described herein are systems and methods for facilitating or executing randomized event sessions using blockchain technology, including on-chain blocks. The on-chain block may be a type of entry in the blockchain, such as a token, including media data or a pointer (e.g., hyperlink) to a non-transitory storage medium storing the media data. An event host device (e.g., server) identifies on-chain blocks including or associated with media data, and incorporates the media data associated with the identified on-chain blocks into the particular randomization event (e.g., gameplay). For example, the host device may determine or assign, for images, videos, or audios included in or associated with the on-chain blocks, corresponding slots of a slot machine game session, a roulette game session, a card game session, or the like. The user device transmits a request to the host device to initiate or participate in a randomized event session. The host device may execute the randomized event session incorporating the media data of the on-chain blocks. The host device may execute software for hosting a cloud-based gaming application. The player-users access the gaming application services using end-user user devices by executing a web browser or locally installed application executed by a user device. The host device establishes the session with the user device of each player-user and executes a randomizing algorithm in connection with the event. The host device generates a user interface based on the results of the randomizing algorithm and the gameplay configuration, where the user interface presents the player-users with options, inputs, and outputs associated with the gameplay. The host device incorporates media data of the on-chain blocks (e.g., images) into the gameplay operations and the gameplay interface. The host device may generate award notifications based upon the results of the randomization algorithm. The host device may assign an award value to a successful end-user and may further assign an award value to each owner of winning on-chain blocks randomly selected by, or selected for, the successful end-user.

Embodiments may include a computer-implemented method for identifying and extracting media data from on-chain blocks. The method can be performed, for example, by one or more processors coupled to non-transitory memory. The method can include receiving a plurality of block identifiers of a plurality of on-chain blocks from one or more user devices of one or more possessor-users. For each on-chain block indicated by each of the plurality of block identifiers, the method can include extracting media data from the on-chain block based on a media type for the media data as determined for the on-chain block. The method can include generating a graphical user interface having the media data of the plurality of on-chain blocks associated with a randomization event session for display at one or more session user devices of one or more player-users according to the media type of the media data. The method can include receiving a request via the graphical user interface to execute a randomization algorithm from a session user device. The method can include executing the randomization algorithm to identify one or more block identifiers corresponding to one or more on-chain blocks. The method can include updating the graphical user interface to display the media data of the one or more on-chain blocks corresponding to the one or more block identifiers as identified by executing the randomization algorithm. The method can include determining, by executing an executable program that is on-chain, a first result value for a player-user associated with the session user device and a second result value for a possessor-user associated with an on-chain block of the one or more on-chain blocks. The method can include transmitting a first result notification indicating the first result value to the session user device and a second result notification indicating the second result value to a user device of the possessor-user, and providing an instruction causing an update to a user database.

In some implementations, the method can include determining that the on-chain block contains the media data in a data structure of the on-chain block, and parsing the data structure to obtain the media data of the on-chain block. In some implementations, the method can include determining that the on-chain block includes a content identifier referencing a distributed storage node containing the media data according to a distributed storage protocol, and retrieving the media data from the distributed storage node indicated by the content identifier. In some implementations, the method can include determining that the on-chain block includes a uniform resource locator referencing a storage media location containing the media data, and retrieving the media data from the storage media location indicated by the uniform resource locator. In some implementations, the media type includes at least one of a static image type, an animated image type, a video type, or an audio type. In some implementations, the method can include determining a weighted value assigned to each on-chain block, wherein the randomization algorithm is executed according to the weighted value assigned to the on-chain block. In some implementations, the weighted value assigned to each on-chain block indicates at least one of: a number of other on-chain blocks having the media data, an exchange value, and a third-party value received from an external value feed computing device. In some implementations, the method can include adjusting a probability of selection for each on-chain block in the randomization algorithm, wherein the probability of selection is inversely proportional to the weighted value of the on-chain block. In some implementations, the method can include updating, by executing a second executable program that is on-chain, an on-chain operational event block to indicate the on-chain block of the possessor-user is transferred from a first distributed address associated with the possessor-user to a second distributed address accessible to the computer, wherein the graphical user interface for the randomization event session is generated using the on-chain block associated with the second distributed address. In some implementations, the method can include updating, by executing the second executable program that is on-chain, a second on-chain operational event block to indicate the on-chain block is transferred from the second distributed address to the first distributed address in response to a triggering condition, wherein the triggering condition comprises at least one of an expiration of a predetermined session duration or receipt of a session termination instruction. In some implementations, the request received from the session user device includes an amount of risk for the randomization event session.

Embodiments may include a system for identifying and extracting media data from on-chain blocks. The system can include a computer comprising a processor. The system can receive a plurality of block identifiers of a plurality of on-chain blocks from one or more user devices of one or more possessor-users. For each on-chain block indicated by each of the plurality of block identifiers, the system can extract media data from the on-chain block based on a media type for the media data as determined for the on-chain block. The system can generate a graphical user interface having the media data of the plurality of on-chain blocks associated with a randomization event session for display at one or more session user devices of one or more player-users according to the media type of the media data. The system can receive a request via the graphical user interface to execute a randomization algorithm from a session user device. The system can execute the randomization algorithm to identify one or more block identifiers corresponding to one or more on-chain blocks. The system can update the graphical user interface to display the media data of the one or more on-chain blocks corresponding to the one or more block identifiers as identified by executing the randomization algorithm. The system can determine, by executing an executable program that is on-chain, a first result value for a player-user associated with the session user device and a second result value for a possessor-user associated with an on-chain block of the one or more on-chain blocks. The system can transmit a first result notification indicating the first result value to the session user device and a second result notification indicating the second result value to a user device of the possessor-user, and provide an instruction causing an update to a user database.

In some implementations, the system can determine that the on-chain block contains the media data in a data structure of the on-chain block, and parse the data structure to obtain the media data of the on-chain block. In some implementations, the system can determine that the on-chain block includes a content identifier referencing a distributed storage node containing the media data according to a distributed storage protocol, and retrieve the media data from the distributed storage node indicated by the content identifier. In some implementations, the system can determine that the on-chain block includes a uniform resource locator referencing a storage media location containing the media data, and retrieve the media data from the storage media location indicated by the uniform resource locator. In some implementations, the system can determine a weighted value assigned to each on-chain block, wherein the system executes the randomization algorithm according to the weighted value assigned to the on-chain block. In some implementations, the system can adjust a probability of selection for each on-chain block in the randomization algorithm, wherein the probability of selection is inversely proportional to the weighted value of the on-chain block. In some implementations, the system can update, by executing a second executable program that is on-chain, an on-chain operational event block to indicate the on-chain block of the possessor-user is transferred from a first distributed address associated with the possessor-user to a second distributed address accessible to the system, wherein the system generates the graphical user interface for the randomization event session using the on-chain block associated with the second distributed address. In some implementations, the system can update, by executing the second executable program that is on-chain, a second on-chain operational event block to indicate the on-chain block is transferred from the second distributed address to the first distributed address in response to a triggering condition, wherein the triggering condition comprises at least one of an expiration of a predetermined session duration or receipt of a session termination instruction.

Embodiments may include a non-transitory machine-readable storage medium storing machine-executable instructions for identifying and extracting media data from on-chain blocks that, when executed by one or more processors, cause the one or more processors to receive a plurality of block identifiers of a plurality of on-chain blocks from one or more user devices of one or more possessor-users. For each on-chain block indicated by each of the plurality of block identifiers, the one or more processors can extract media data from the on-chain block based on a media type for the media data as determined for the on-chain block. The one or more processors can generate a graphical user interface having the media data of the plurality of on-chain blocks associated with a randomization event session for display at one or more session user devices of one or more player-users according to the media type of the media data. The one or more processors can receive a request via the graphical user interface to execute a randomization algorithm from a session user device. The one or more processors can execute the randomization algorithm to identify one or more block identifiers corresponding to one or more on-chain blocks. The one or more processors can update the graphical user interface to display the media data of the one or more on-chain blocks corresponding to the one or more block identifiers as identified by executing the randomization algorithm. The one or more processors can determine, by executing an executable program that is on-chain, a first result value for a player-user associated with the session user device and a second result value for a possessor-user associated with an on-chain block of the one or more on-chain blocks. The one or more processors can transmit a first result notification indicating the first result value to the session user device and a second result notification indicating the second result value to a user device of the possessor-user, and provide an instruction causing an update to a user database.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1A is a diagram depicting components of a system for hosting and executing randomized event session using on-chain blocks, according to embodiments.

FIG. 1B is a diagram depicting dataflow and operations for the blockchain including a plurality of on-chain blocks in the system of FIG. 1A, according to embodiments.

FIG. 2 is a flowchart illustrating operations of a method for executing a randomized event session based on on-chain blocks, according to embodiments.

FIG. 3 is a flowchart illustrating operations of a method for distributing an award to owners of one or more on-chain blocks for a randomized event session, according to embodiments.

FIG. 4 is a flowchart depicting operations of a computer-implemented method for identifying and extracting media data from on-chain blocks, according to embodiments.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Described herein are systems and methods for extracting media data from on-chain blocks of a distributed ledger and incorporating the extracted media data into randomized event sessions executed by a host computing device. Distributed ledger technologies, such as blockchains, can store or reference digital media data within discrete data entries (sometimes referred to as “blocks” or “tokens”), where each entry can include a unique identifier that distinguishes the entry from other entries on the ledger. The unique identifier can render the entry non-fungible, such that the entry is non-interchangeable with other entries or blocks of the distributed ledger; an example of a type of non-interchangeable blocks includes non-fungible tokens (NFTs). The on-chain blocks can include media data directly within the block or can include a pointer to a non-transitory storage medium storing the media data. Non-limiting examples of media data can include image data, video data, audio data, or any combination of these data types. Computing systems that host interactive sessions involving randomized outcomes, such as gaming platforms or event session servers, can execute randomization algorithms to generate random or pseudo-random results and can determine session outcomes based on the generated results. User devices can participate as nodes of the distributed ledger and can communicate with event host devices over one or more networks to initiate or participate in randomized event sessions.

Conventional randomized event platforms lack technical mechanisms for dynamically retrieving and rendering media data from distributed ledger entries into session interfaces in real time. When media data is stored on a blockchain or referenced via on-chain pointers, technical challenges arise in retrieving media data from distributed ledger nodes that may have varying response latencies, in parsing blockchain data structures to extract embedded media or resolve pointers to off-chain storage locations, and in converting blockchain-native data formats into display-ready formats suitable for real-time rendering on gaming interfaces. The media data may be stored in heterogeneous formats and locations, where media data may be directly embedded on-chain within the NFT, referenced via decentralized storage protocols, or linked to centralized storage servers via uniform resource locators (URLs). Each storage approach requires different retrieval and decoding processes to obtain the underlying media data. Conventional gaming display systems also lack mechanisms for synchronizing randomization algorithm outputs with the presentation of blockchain-sourced visual elements, where a failure to synchronize the randomization result with the user interface presentation can result in inconsistencies between the distributed ledger state and the visual output presented to the user. Furthermore, conventional systems do not provide a technical mechanism for programmatically adjusting event configuration parameters based on attributes derived from on-chain or off-chain valuation data associated with ledger entries, nor do conventional systems provide a mechanism for executing on-chain programs that automatically allocate fractional award values to multiple distributed addresses associated with different participants based on session outcomes.

Conventional gaming systems may include or reference locally stored or server-hosted media assets with predetermined visual elements, which presents technical limitations when attempting to incorporate dynamically owned digital assets in on-chain blocks, such as non-fungible tokens (NFTs), into real-time gameplay displays. Non-limiting examples of technical limitations include challenges in retrieving media data from distributed ledger nodes with varying response latencies, parsing blockchain data structures to extract embedded media or resolve pointers to off-chain storage locations, converting blockchain-native data formats into display-ready formats suitable for real-time rendering, handling heterogeneous storage formats including on-chain embedded media, decentralized storage protocols such as IPFS, and centralized URL-based storage, dynamically adapting user interfaces to present diverse media types whose formats are not known until runtime, synchronizing randomization algorithm outputs with blockchain-sourced visual elements to ensure display accuracy, and coordinating multiplayer online gambling sessions involving geographically distributed participants with varying network latencies and display capabilities.

The embodiments disclosed herein address these technological shortcomings through improved systems and methods that enable, for example, extraction of media data from on-chain blocks stored in diverse formats and locations by determining storage format type and executing appropriate retrieval mechanisms, dynamic generation of gaming user interfaces that are configured with extracted media data and that adapt in real time to present diverse media types including static images, animated images, video sequences, and audio content, synchronized updating of gaming user interfaces based on randomization algorithm outputs and event session state data (or game state) such that displayed graphical user interface elements containing the media data selected or identified in random selections, and coordination of multiplayer online gambling sessions that manage concurrent connections from multiple user devices while maintaining game state consistency and distributing awards to both winning players and on-chain block owners whose media data contributed to winning outcomes.

The techniques described herein provide systems and methods for extracting media data from on-chain blocks, dynamically generating user interfaces populated with the extracted media data, and executing randomized event sessions that incorporate the extracted media into event positions. The techniques described herein can employ an event host device that receives block identifiers corresponding to blocks of a distributed ledger from one or more user devices, accesses the blocks via a blockchain control system using the block identifiers, and obtains media data either directly from the blocks or from storage locations referenced by identifiers, addresses, or pointers in the blocks. The event host device can assign the obtained media data to corresponding event positions of a randomized event session, execute a randomization algorithm to select one or more blocks based on randomly generated values, and determine award values for session participants and for owners of the selected blocks by executing an on-chain executable program that computes a first award value and a second award value based upon a fraction of the first award value.

An event host device can receive, from one or more user devices, block identifiers together with a permission indication to use the blocks or the associated media data in randomized event sessions. The event host device can query the blockchain control system and access blocks referenced by the block identifiers, where the event host device can obtain the media data from on-chain storage or from off-chain storage as indicated by pointers in the blocks. The event host device can then assign the media data to event positions of a session interface, where each event position can correspond to a value or position number such that a position or a corresponding block can be identified by the corresponding value. When a session user device transmits a request to initiate a randomized event session, the event host device can execute a randomization algorithm that generates one or more random values corresponding to one or more event positions or block identifiers. The event host device can determine the outcome of the randomized event session based on the generated random values, where outcome determination can involve pattern-based evaluation for slot-style sessions or comparison-based evaluation for roulette-style sessions. The event host device can then execute the on-chain executable program to determine a first award value for a user account associated with the session user device and a second award value for an owner associated with a distributed address holding the selected block, where the second award value can be based upon a fraction of the first award value. The event host device can generate award notifications and transmit the award notifications to the blockchain control system or a third-party financial system to authorize payment to the corresponding payment accounts.

By providing the retrieval pipeline, the randomization-to-display synchronization, and the on-chain award allocation described above, the techniques described herein can address the technical challenges of extracting and rendering blockchain-sourced media data in real-time event session interfaces. The retrieval pipeline can resolve heterogeneous storage formats, including on-chain embedded media, pointer-referenced decentralized storage, and URL-linked centralized storage, into display-ready media for user interface generation. The techniques described herein can synchronize randomization algorithm outputs with the presentation of blockchain-verified visual elements, such that the user interface presentation remains consistent with the distributed ledger state. The techniques described herein can further provide a programmatic adjustment of event configuration parameters based on weighted values derived from on-chain or off-chain valuation data associated with the blocks, such that the probability of selection for a given block can correspond to the weighted value of the block. The techniques described herein can also execute on-chain programs to automatically allocate fractional award values to multiple distributed addresses associated with different participants based on session outcomes, providing a technical improvement over conventional systems that lack automated, ledger-verified award distribution across multiple parties in a single session transaction.

An event host device receives token identifiers corresponding to NFTs from user devices, where each NFT includes media data or a pointer to media data stored in one of multiple heterogeneous storage formats. The event host device determines the storage format type for each NFT and executes a corresponding retrieval mechanism to extract the media data. For NFTs with media embedded directly on-chain, the event host device parses the blockchain data structure to extract the media. For NFTs referencing decentralized storage via IPFS, the event host device resolves the content identifier and retrieves the media from distributed storage nodes. For NFTs linking to centralized storage via URLs, the event host device fetches the media from the specified network location. After retrieval, the event host device converts the media data into a display-ready format suitable for incorporation into a gaming user interface.

The event host device dynamically generates a gaming user interface configured with the extracted NFT media. Because the media type associated with each NFT is not known until the media data is retrieved and analyzed, the event host device determines the media type at runtime based on characteristics of the retrieved data, such as file headers, data structures, or metadata. The event host device then configures the gaming user interface to present the media according to a type of data, which may include various user interface operations, such as rendering static images in display elements, playback and display of animated images or video sequences with appropriate timing and playback controls, or outputting audio content through audio interfaces, among others. The dynamic adaptation enables the gaming system to incorporate NFT media of any supported type without requiring advance knowledge or manual configuration of the media formats.

The event host device executes a randomization algorithm that randomly identifies one or more token identifiers associated with NFTs, and updates the gaming user interface using the media data of the identified NFTs in synchronization with the randomization output. The synchronization ensures that the visual elements displayed on the user interface accurately reflect the blockchain-verified random selection, preventing inconsistencies between the distributed ledger state and the visual output presented to users. In gaming contexts such as slot machine sessions or roulette sessions, this synchronized updating enables the display of randomly selected NFT media as winning outcomes while maintaining verifiable correspondence between the randomization result and the displayed content.

The event host device coordinates multiplayer online gambling sessions by managing concurrent connections from multiple user devices over a network. Each user device may contribute NFTs to a shared gaming pool or participate in wagering on outcomes involving NFTs contributed by other participants. The event host device extracts, renders, and displays NFT media in real time across all connected user devices while maintaining game state consistency, such that participants in a multiplayer session observe the same NFT media elements and randomization outcomes despite varying network latencies and device display capabilities. When a randomization outcome affects multiple participants, the event host device determines and distributes awards to winning players and also determines fractional awards for owners of NFTs whose media was randomly selected or contributed to the winning outcome.

Described herein are systems and methods for facilitating or executing randomized event sessions using blockchain technology, including NFTs. The NFT is a token that includes media data or a pointer (e.g., hyperlink) to a non-transitory storage medium storing the media data. Non-limiting examples of the media data may include, but are not limited to, image data, video data, audio data, or any combination of them. Each NFT may include a unique token identifier that uniquely identifies the particular NFT and renders the particular NFT non-fungible, such that the NFT is essentially non-interchangeable with other NFTs or blocks of the blockchain.

Embodiments may include a system having user devices that participate as nodes of the blockchain, where the NFTs store identifiers, addresses or pointers to NFTs, and an event host device (sometimes referred to as “host device” herein) that controls or maintains randomized event sessions according to the NFTs. Randomized event sessions may include a game session, a gambling application session, simulations, modeling, or any event session that an outcome of the session is determined based on random values.

The user device and the host device may be any computing devices, such as smart phones, desktop computers, tablet PCs, servers, etc. In one approach, the host device identifies NFTs including or associated with media data, and obtain the media data associated with the identified NFTs. The host device may incorporate the media data into the randomized event session. For example, the host device may determine or assign, for images, videos, or audios included in or associated with the NFTs, corresponding slots of a slot machine game session, a roulette game session, a card game session, etc. In one approach, the user device transmits a request to the host device to initiate or participate in a randomized event session. The host device may execute the randomized event session incorporating the media. Alternatively or additionally, the host device may allow the user device to execute the randomized event session incorporating the media.

For instance, the host device may execute software for hosting a cloud-based gaming application. The end-users access the gaming application services by executing a web browser or locally installed application executed by a user device. The end-user may enter an input for selecting a particular event, such as a game (e.g., roulette game, slots game) or other service, instructing the user device to establish a session with the host device. The host device establishes the session with each of the user devices and executes a randomizing algorithm in connection with the event. The host device generates a user interface based on the results of the randomizing algorithm and the gameplay configuration, where the user interface presents the player-users with options, inputs, and outputs associated with the gameplay. The host device incorporates media data of the NFTs (e.g., images) into the gameplay operations and the gameplay interface.

As an example, the host device includes a webserver that hosts a gaming website allowing users to access gaming sessions (or “rooms”) for particular games, such as roulette, slots, lottery, or other games. The host device establishes event sessions with the user devices that accessed the particular room. The host device generates user interfaces presenting the user devices with gameplay and/or administrative options. The host device executes the randomization algorithm to generate random or pseudo-random results, thereby emulating the element of chance related to the gameplay. The host device extracts an image (or other media data) of a plurality of NFTs and incorporates the image into the gameplay and the gameplay interface.

In a roulette example, the user interface includes the NFTs available for the users to select for wagers. The host device generates the gameplay interface representing a virtual roulette wheel containing the images from the NFTs. The player may select a particular NFT on which to wager. The randomization algorithm then randomly selects an image, address, or other NFT-identifier as the winning NFT. The host device determines that one or more players won, when the one or more players entered wagers for the particular winning NFT.

In a slots example, the host device generates a user interface representing reels of a virtual slot machine, where the reels include the images of the NFTs. The randomization algorithm then randomly selects an image, address, or other NFT-identifier for each of the virtual reels. The host device assigns score values to the NFTs. In a conventional slot game, a winner is determined by the pictures that line up with a pay line across the reels, and the payout depends on which pictures are aligned with the pay line. In the embodiments herein, the host device may determine whether the player won based on the score values assigned to the pictures and/or NFTs selected by the randomization algorithm for the virtual reels. The host device may also initiate an automatic transmission representing a payout to an owner who has an NFT appearing in the pay line for a winning player.

In a “competitive” slots example, the randomization algorithm randomly selects the NFTs for each player's virtual slot machine. The host device determines output scores for each particular player based upon the score values of the NFTs randomly selected by the host device for the particular player, and the player with the highest output score wins. The host device identifies the winning player having the winning output score. The host device may also initiate an automatic transmission representing a payout to an owner who has an NFT appearing in the selected images for a winning player.

In some implementations, the host device may determine weighted values of NFTs (or weighted values of the associated media), and execute a randomized event algorithm according to the weighted values. For example, the host device may adjust a probability of success with a NFT in the randomized event session, according to the weighted value of the NFT (or the weighted value of the associated media). A weighted value of the NFT may correspond to or may be proportional to the market value of the NFT traded on a public market platform (e.g., Rarible, NFT stars, Crypto. com, VeVe, etc.). In one aspect, the host device assigns a weighted value for a NFT, according to a number of other NFTs having the media data, a currency value, a third-party value received from a third-party device, or any combination of them. Assuming for an example that a first image of a particular dog has a higher value than a second image of a raven, the host device may assign or allocate the first image of the dog to a fewer number of slots than a number of slots allocated for the second image of the raven in a slot machine game session or a roulette game session. Hence, the probability of winning the slot machine game session or the roulette game session with the images of the dog may be lower than the probability of winning the slot machine game session or the roulette game session with the images of the raven.

The host device may provide different amounts of award for the success in the randomized event session to user devices, according to values of the NFTs. In one approach, the host device may determine the amount of award for the success in the randomized event session, according to the adjusted probability of success. For example, the host device may assign or allocate a larger amount of award, if the user wins the slot machine game session or the roulette game session with a slot including media with a lower probability of success. In one approach, the host device may determine the amount of award for the success in the randomized event session to be proportional to the values of the NFTs. For example, the host device may assign or allocate a greater amount of award if the user wins the slot machine game session with a slot including a rarer NFT or with more valuable NFT.

The host device accesses the NFTs of other owners to incorporate the media data included in or associated with the NFTs into the randomized event session, and automatically distribute a portion or a fraction of award. The host device may automatically allocate the award to one or more owners or accounts associated with the NFTs corresponding to portions of the award. In one approach, the host device may determine an amount of award for the owner or account associated with the NFT to be a fraction of the award allocated to the player that initiated or participated in the randomized event session. In some circumstances, the player may be a different user from the owner associated with the NFT. The owners of the NFTs are encouraged and incentivized to share or allow the host device to utilize the NFTs for the randomized event sessions.

Although various embodiments disclosed herein are provided with respect to a roulette game session or a slot machine game session, the principle of incorporating NFTs or digital media data of the NFTs and distributing award according to values of the NFTs disclosed herein can be applied to any event session with outcomes determined based on randomness or random values.

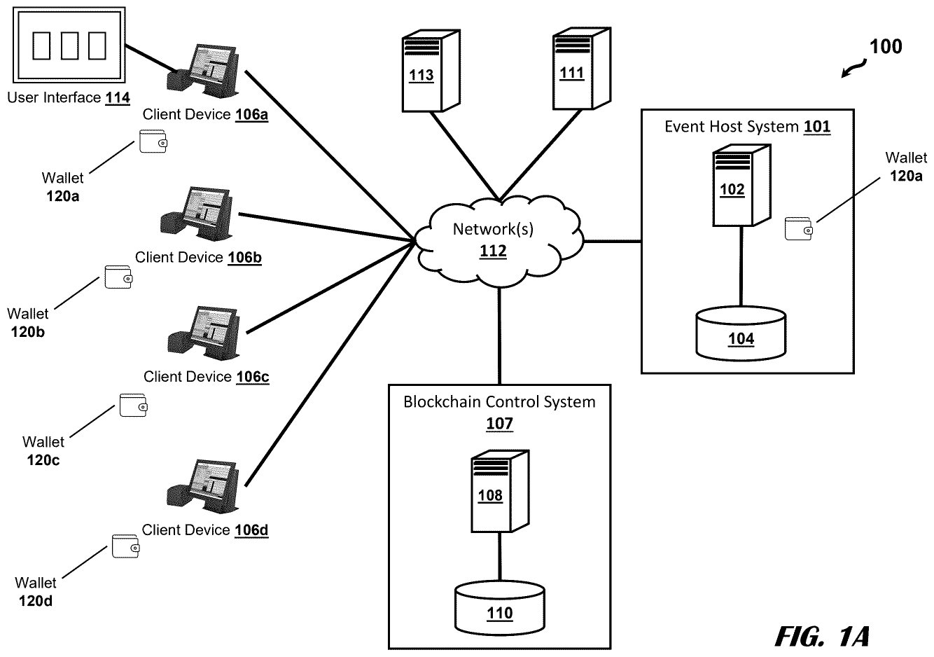

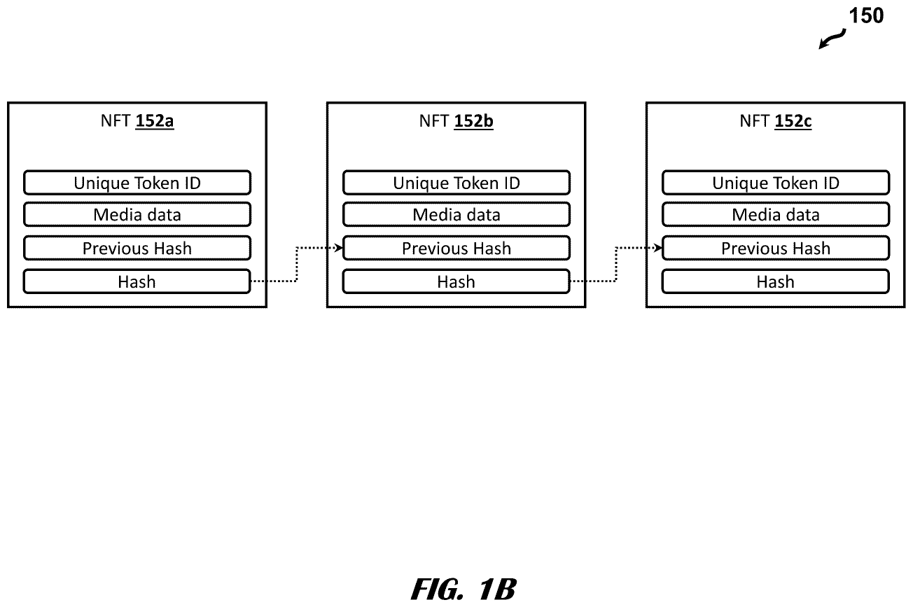

FIGS. 1A-1B depict components of a system 100 for implementing randomized events using on-chain blocks 152a-152c (collectively referred to as on-chain blocks 152) of a blockchain 150, according to an embodiment. Turning to FIG. 1A, the system 100 includes an event host system 101, any number of user computing devices 106a-106d (e.g., collectively referred to as user devices 106), a blockchain oracle server 111, a service provider server 113 of a third-party payment service provider system, and a blockchain control system 107, which communicate via one or more networks 112. The event host system 101 includes an event host device 102 and a host database 104, which communicates with the event host device 102. The blockchain control system 107 includes a blockchain control device 108 and a blockchain control database 110, which communicates with the blockchain control device 108. The blockchain oracle server 111 can communicate with the event host system 101, the blockchain control system 107, and/or the user devices 106 via the network 112 to provide off-chain data, on-chain data, and/or external valuations to one or more of the event host device 102 and/or the blockchain control device 108. The devices of the system 100 include and execute software programming for any number of crypto wallets 120a-120d (generally referred to as crypto wallets 120) having distributed addresses exchanging and tracking ownership or custody over on-chain blocks 152 of a blockchain. In some implementations, the blockchain oracle server 111 can retrieve market valuations, pricing data, and/or metadata from one or more external data sources (e.g., public market platforms, third-party pricing feeds, external application programming interfaces) and transmit the retrieved data to the event host device 102 and/or the blockchain control device 108 for use in determining weighted values of the on-chain blocks 152.

Embodiments may comprise additional or alternative components or omit certain components from those of FIG. 1A, and still fall within the scope of this disclosure. The system 100 may, for example, include any number of event host devices 102, user devices 106, and blockchain control devices 108. In some implementations, the system 100 may include a service provider server 113 of a third-party payment service provider system that communicates with the user devices 106, the event host system 101, the blockchain control system 107, or any combination thereof, through the network 112. Embodiments may include or otherwise implement any number of devices capable of performing the various features and tasks described herein. For example, FIG. 1A shows the event host device 102 as a distinct computing device from the host database 104, though a single computing device may comprise both the event host device 102 and the host database 104. As another example, FIG. 1A shows the event host system 101 and the blockchain control system 107 as distinct computing systems, though the event host system 101 and the blockchain control system 107 may be implemented as a single system or operated by a single entity.

The service provider server 113 of a payment system hosts or communicates with one or more user information databases storing account information for player-users, possessor-users, or both. The user databases of the provider server 113 may be maintained by, for example, the event host system 101, a bank, casino operator, payment processor, gaming platform, blockchain control system, or other account management system. For instance, a device (e.g., event host device 102) of the event host system 101 may transmit or otherwise provide, as part of a result notification or contemporaneously with a result notification, machine-executable instructions that instruction or otherwise cause software programming of a receiving computing device (e.g., service provider server 113, event host device 102, user device 106) to update the user database of the service provider server 113 or other databases of the system 100 according to a result value. For example, the instruction may cause the service provider server 113 of bank or casino to update one or more fields of user account information (a balance field, pending-payment field, rewards field, casino credit field, transaction history field, audit field) associated with a possessor-user whose on-chain block 152 contributed to a randomization outcome. In this way, the event host system 101 may update account information of the player-users or owner-users based the award results of the randomization event owed to each player-user and/or each owner-user without transferring of permanent ownership of the winning on-chain block 152.

The system 100 can distribute processing operations across the event host system 101, the blockchain control system 107, and/or the user devices 106. In some implementations, one or more operations performed by the event host system 101 can be performed by the blockchain control system 107 and/or the user devices 106. For example, the blockchain control system 107 can execute a randomization algorithm, determine award values, and/or generate award notifications on behalf of the event host system 101 when the event host device 102 delegates such operations to the blockchain control device 108. In some implementations, one or more operations performed by a user device 106 can be performed by the event host system 101 and/or the blockchain control system 107. For example, a media extraction operation initiated at a user device 106 can instead be performed by the event host device 102, which can retrieve media data from the blockchain 150 via the blockchain control device 108 and transmit the retrieved media data to the user device 106 for display on the user interface 114. In some implementations, one or more operations performed by the blockchain control system 107 can be performed by the event host device 102 and/or the user devices 106. For example, the event host device 102 can execute an on-chain executable program to update transaction data of the blockchain 150 without routing the execution request through the blockchain control device 108, provided the event host device 102 participates as a node of the blockchain 150. The redistribution of operations across the event host system 101, the blockchain control system 107, and the user devices 106 can vary across embodiments based on computational resource availability, network latency between the respective devices, and/or the type of randomized event session being executed.

The various components of the system 100, and the computing system infrastructures (e.g., event host system 101, blockchain control system 107), may be connected with each other via hardware and software components of one or more external networks or internal networks (generally referred to as networks 112). Examples of such networks 112 include, but are not limited to, Local Area Network (LAN), Wireless Local Area Network (WLAN), Metropolitan Area Network (MAN), Wide Area Network (WAN), and the Internet. The communication over any particular network 112 may be performed in accordance with various communication protocols, such as Transmission Control Protocol and Internet Protocol (TCP/IP), User Datagram Protocol (UDP), and IEEE communication protocols, among others. The computing infrastructures include the event host system 101 and the blockchain control system 107, each of which comprises any number of computing devices (e.g., event host device 102, blockchain control device 108), non-transitory machine readable storage (e.g., host database 104, blockchain control database 110), and one or more internal computing networks, which may be distinct from the one or more system network 112, among other components. For ease of describing certain aspects and use cases, the system 100 of FIG. 1A includes the event host system 101 and the blockchain control system 107, though embodiments may include any number of such computing system infrastructures of various types.

The blockchain 150 is a decentralized digital ledger that records transactions across multiple computers (or chain nodes) participating in the blockchain 150. The entries into the blockchain 150 may include blocks (or tokens) containing immutable data that cannot be altered retroactively. A block may refer to an on-chain digital unit (e.g., a token, coin, or other digital ledger entry unit) that is generated (or minted), transferred, and/or removed (or burned) by execution of one or more on-chain programs (e.g., a smart contract) or off-chain programs associated with the blockchain 150. For instance, a token (or other type of block) may be generated and recorded by the on-chain program in an entry of the blockchain 150 as part of the distributed ledger state of the blockchain 150. Examples of types of blockchains include public blockchains, such as Bitcoin and Ethereum, which are open to any computing device or user and provide transparency and security through proof-of-work or proof-of-stake mechanisms, and private blockchains, such as Hyperledger and Corda.

An on-chain block 152 on the blockchain 150 may represent digital media that is generated, transferred, and/or removed by execution of one or more on-chain programs (e.g., smart contracts) or off-chain programs associated with the blockchain 150. The devices of the system 100, such as the event host device 102, may mint or burn tokens by executing the various operations of the smart contracts or other programming described herein. The event host device 102 may, for example, generate or mint tokens to represent on-chain blocks including or associated with media data, such as image data, video data, and audio data, among other potential types of media data. An on-chain block 152 may be implemented according to various token standards or other distributed ledger representations that are transferable and capable of being generated (minted), transferred, and removed (burned). The event host device 102 or other devices of the system 100 may further determine and assign values to the on-chain blocks 152 based upon various computer-executed operations described herein. In some implementations, on-chain block 152 may include non-fungible tokens (NFTs) that each include a unique token identifier (ID) rendering the respective on-chain block 152 as being non-interchangeable with other on-chain blocks 152 of the blockchain 150. These on-chain blocks 152 may be used for randomized event session operations within the system 100.

A cryptographic wallet (or crypto wallet 120), within the context of blockchain technology, functions as a digital tool that allows users to manage tokens and digitally represent possession or ownership of on-chain blocks. Each crypto wallet 120 is assigned a unique distributed address, acting as an identifier and location within the blockchain 150 where transactions and on-chain blocks 152 can be directed. This address enables the crypto wallet 120 to receive, store, and exchange tokens and/or on-chain blocks, such that the rightful owner can access or transfer the tokens and/or on-chain blocks. When a transaction is initiated, the crypto wallet 120 interacts with the blockchain 150 to validate and record the transfer, maintaining the integrity and transparency of the distributed ledger of the blockchain 150. In the system 100, the crypto wallets 120 may include a first crypto wallet 120a associated with the event host system 101, a second crypto wallet 120b associated with a first user of a second user device 106b, a third crypto wallet 120c associated with a second user of a third user device 106c, and a fourth crypto wallet 120d associated with a third user of a fourth user device 106d, among any number of additional end-user crypto wallets 120 of registered users having user accounts with the event host system 101 and/or blockchain control system 107.

Smart contracts are self-executing software programs having various types of executable software routines that instruct one or more participating chain-nodes of the blockchain 150, such as the event host device 102 or the user devices 106, to perform operations. These operations may, for example, reflect terms of an agreement as written into lines of code of the smart contracts as functional operations for the chain nodes. A smart contract operates on the blockchain 150 and is invoked or executed by certain participating nodes (e.g., event host device 102, blockchain control device 108, user devices 106). The smart contracts may enforce and execute the agreed-upon terms when specific conditions are met, where the participating nodes may programmatically and automatically perform various operations (e.g., transferring custody of on-chain blocks 152, determining award values, distributing fractional award values to distributed addresses). A smart contract is an example of an on-chain program, as used herein, and an on-chain program may include one or more routines that are executed by one or more chain-nodes of the blockchain 150. Non-limiting examples of such routines of the smart contracts may include a block-generating routine (or generating or minting function) to generate or mint tokens, a transferring routine to transfer a token or on-chain block between distributed addresses (e.g., crypto wallets 120), a burning routine to transfer the token to a burn distributed address or otherwise render the token inaccessible or invalid, and/or an award determination routine to compute award values and generate transaction data indicating payment authorizations for one or more distributed addresses.

In some implementations, the smart contract or another executable program that is on-chain can generate or authorize result notification data that includes executable instructions for updating account information outside the blockchain 150. For example, after computing the second award value for the owner of the randomly selected on-chain block, the on-chain executable program can generate transaction data or event data that the event host device 102 uses to form a second result notification. The second result notification can include executable instructions that cause a third-party device to update account information of the owner, such as by updating a user information database record (e.g., database of a service provider server 113) corresponding to a payment account, casino account, rewards account, or crypto wallet associated with the owner. In some implementations, the executable instructions included in the result notification can cause the service provider server 113 to write or store an account update record that references the on-chain block, the randomization event session, and the second result value.

An example smart contract for transferring temporary custody of on-chain blocks 152 by the event host device 102 involves a scenario where the contract is triggered by a randomized event session initiation. When the event host device 102 determines that one or more on-chain blocks 152 are to be incorporated into a randomized event session, the event host device 102 initiates the smart contract to transfer temporary custody of one or more on-chain blocks 152 to a first distributed address of a first crypto wallet 120a of the event host system 101 and accessible to the event host device 102, from a second distributed address of a second crypto wallet 120b associated with an owner of the on-chain blocks 152, which may be hosted at the first user device 106a. The smart contract may validate the transfer conditions to confirm that the permission requirements are met, such as confirming that a consent instruction has been received from the owner and/or that the on-chain blocks 152 referenced by the block identifiers are currently held at the second distributed address associated with the owner-user. Once validated, the contract proceeds to update a transaction block and/or transaction data on the blockchain 150 to indicate that the on-chain blocks 152 are in temporary control of the first distributed address of the first crypto wallet 120a of the event host system 101 for the duration of the randomized event session.

Another example smart contract for determining and distributing award values by the event host device 102 involves a scenario where the contract is triggered by a successful outcome in the randomized event session. When the event host device 102 determines that a player-user achieved a winning condition based on a randomly selected on-chain block, the event host device 102 invokes the smart contract to compute a first award value for the player-user and a second award value for an owner of the randomly selected on-chain block. The smart contract may verify the session outcome details, confirming that the randomization result corresponds to a winning condition as defined by the session configuration. Once validated, the contract proceeds to compute the first award value based on the amount of risk and/or the weighted value of the randomly selected on-chain block 152, and to compute the second award value as a fraction of the first award value. The smart contract may generate transaction data on the blockchain 150 authorizing transfer of the first award value according to a preconfigured form of payment (e.g., payment account for fiat currency, distributed address of the player-user's crypto wallet 120 for crypto-based payments) and transfer of the second award value according to a preconfigured form of payment (e.g., payment account for fiat currency, distributed address of the owner-user's crypto wallet 120 for crypto-based payments). In some implementations, the smart contract may interact with the blockchain oracle server 111 to obtain current valuation data for the randomly selected on-chain block when computing the weighted value and/or the fractional coefficient applied to determine the second award value.

In some implementations, after computing or authorizing the second award value, the smart contract or other on-chain executable program can generate event data, transaction data, or authorization data that the event host device 102 uses to transmit or provide an instruction causing an update to a user information database at the service provider server 113 or other device or database of the system 100. The instruction may identify the possessor-user, the on-chain block 152, the randomized event session, the second award value, and a destination account or account record to be updated. Optionally, the instruction may include a digitally signed authorization, a smart-contract event payload, a database update command instruction, an API request, or other machine-readable data that causes a receiving computing device (e.g., service provider server 113, blockchain control device 108, user device 106, event host device 102) to update account information associated with the owner-user who owns a winning on-chain block 152. The receiving computing device may verify the event data, transaction data, or authorization data before updating the user database of the service provider server 113 or other device or database of the system 100.

The user devices 106 include computing devices of end-users for interacting with the services and features of the event host system 101 and other components of the system 100. The user devices 106 may include devices operated by NFT owner-users (e.g., users who contribute on-chain blocks 152 for incorporation into randomized event sessions), devices operated by player-users (e.g., users who initiate and/or participate in randomized event sessions), and/or devices operated by users who serve in both roles. The user devices 106 may include any electronic device comprising hardware components (e.g., one or more processors, non-transitory machine-readable storage, display hardware, network interface controllers, etc.) and software components (e.g., web browsers, locally installed applications associated with the event host system 101, crypto wallet software of the crypto wallet 120, etc.) that enable the user devices 106 to perform the various processes and functions described herein. For instance, the user devices 106 may access a portal and/or a cloud-based application hosted by the event host device 102 of the event host system 101 via one or more networks 112 and, for example, submit block identifiers and permission indications for on-chain blocks 152, initiate randomized event sessions, place wagers, submit placement auction bids, receive award notifications, and/or perform other types of operational interactions with the system 100.

The system 100 can include any number of computing devices that participate as nodes of a distributed ledger (e.g., blockchain 150), such as the event host device 102, the blockchain control device 108, and the user devices 106. The system 100 can further include the blockchain control system 107 and the event host system 101. For ease of description, the system 100 concentrates and centralizes certain features of the blockchain 150 at the blockchain control system 107, though the amount of centralization may vary across embodiments. In some implementations, the blockchain control system 107 can generate on-chain blocks 152 (e.g., tokens, NFTs) including or associated with media data, such as image data, video data, audio data, or any combination of them. For example, the blockchain control device 108 can execute minting operations that take one or more cryptographic values (e.g., an encryption key, a digital signature, a digital certificate, a salt, and/or a seed) together with unique media data to generate a new on-chain block 152 containing one or more unique identifiers that render the on-chain block 152 non-fungible. In some implementations, the user devices 106 and/or the event host device 102 can instruct the blockchain control device 108 to mint on-chain blocks 152, and the blockchain control device 108 can distribute the minted on-chain blocks 152 to corresponding distributed addresses associated with the requesting devices.

The blockchain control system 107 may issue and validate cryptographic certificates of on-chain blocks 152. In FIG. 1A, the blockchain control device 108 of the blockchain control system 107 executes certificate authority software to issue, evaluate, and revoke certificates, and the blockchain control database 110 stores certificates, cryptographic keys, and other information related to the certificates. Embodiments may include any number of certificate authorities hosted by any number of computing devices (e.g., blockchain control device 108) and not limited to a single certificate authority. In some implementations, the blockchain control device 108 can generate a certificate or a set of cryptographic keys for each on-chain block 152 at the time the on-chain block 152 is minted, such that the certificate or set of cryptographic keys is associated with the unique token identifier of the on-chain block 152. For example, the blockchain control device 108 can receive a minting request from a user device 106 or from the event host device 102, generate the on-chain block 152 with a corresponding unique token identifier, and issue a certificate binding the unique token identifier to a distributed address of the requesting device. The blockchain control device 108 can store the issued certificate and the corresponding cryptographic keys in the blockchain control database 110 for subsequent retrieval when performing validation operations, custody transfer operations, and/or access operations associated with the on-chain block 152. In some implementations, the blockchain control device 108 can evaluate a previously issued certificate in response to a request from the event host device 102 to access media data of a on-chain block 152, and the blockchain control device 108 can permit or deny the access request based on whether the certificate remains valid (e.g., has not been revoked, has not expired, corresponds to a verified distributed address, etc.).

The blockchain control device 108 executes software programming related to managing the blockchain 150 and hosting the various services described herein. The blockchain control device 108 includes any computing device having computing hardware (e.g., processors, non-transitory memory) and software for performing the various processes and tasks described herein. Non-limiting examples of the blockchain control device 108 include servers, desktops, laptops, tablets, and the like. Although FIG. 1A shows one computing device as the blockchain control device 108, the blockchain control device 108 could include any number of computing devices.

The blockchain control device 108 can host a cloud-based application or software program (e.g., a decentralized application, a crypto wallet interface, a certificate authority service, etc.) for facilitating operations of the system 100 related to the blockchain 150. In some implementations, the cloud-based application can be entirely web-based (e.g., a web portal accessible via a uniform resource locator), whereby the computing devices of the system 100 access the cloud-based application through a web browser executed at the respective computing device. For example, the blockchain control device 108 (or another computing device of the blockchain control system 107) can execute webserver software that hosts a website providing a graphical user interface through which end-users view blockchain state data, initiate token transfer operations, and/or submit minting requests for new on-chain blocks 152. In some implementations, the blockchain control device 108 can publish the cloud-based application as a locally installable software package distributed to the computing devices of the system 100. For example, the blockchain control device 108 can distribute an installer package to one or more user devices 106 via the network 112, and each user device 106 can execute the installed application locally to access services hosted by the blockchain control device 108 without requiring a web browser. In operation, a user device 106 can execute the cloud-based application (e.g., a browser-based client, a locally installed software program, etc.) to establish a network session with the blockchain control device 108, which can present a user interface to an end-user and can receive input selections from the end-user corresponding to operations associated with the blockchain 150 and/or the on-chain blocks 152.

The blockchain control device 108 may execute operations to function as a certificate authority for the blockchain control system 107. In this capacity, the blockchain control device 108 can issue, evaluate, and/or revoke certificates and/or encryption keys for end-users, entities, and/or crypto wallets 120 (e.g., crypto wallets 120 belonging to users of the user devices 106, crypto wallets 120 associated with the event host system 101, etc.) that participate in operations involving the on-chain blocks 152. The blockchain control device 108 (or another device of the system 100, such as the event host device 102) may further execute software for performing authentication operations to authenticate users, crypto wallets 120, and/or the on-chain blocks 152. In some implementations, the blockchain control device 108 can issue each on-chain block 152 or crypto wallet 120 a certificate and/or a set of cryptographic keys at the time of minting and/or registration. For example, the blockchain control device 108 can bind a unique token identifier of a on-chain block 152 to a distributed address of a crypto wallets 120 of the owning entity by generating a digital certificate that associates the unique token identifier with a public key corresponding to the distributed address. In some implementations, the blockchain control device 108 can issue a certificate to a crypto wallets 120 of a user of a user device 106 and/or to a crypto wallet 120 of the event host system 101, such that operations involving custody transfers of the on-chain blocks 152 between the user's crypto wallet 120 and the crypto wallet 120 of the event host system 101 can be verified against the respective issued certificates. The issued certificates and/or sets of cryptographic keys can be accessed by the blockchain control device 108 when performing subsequent operations associated with the on-chain blocks 152, such as custody transfer operations, media access operations, and/or event session incorporation operations. In some implementations, the blockchain control device 108 can evaluate a previously issued certificate in response to receiving an access request from the event host device 102 and/or a user device 106, and can permit and/or deny the access request based on the validity state of the certificate (e.g., whether the certificate has been revoked, whether the certificate has expired, whether the certificate corresponds to an authorized distributed address of the user's crypto wallet 120 or the crypto wallet 120 of the event host system 101).

In some implementations, the blockchain control device 108 can reference NFT-owner consent thresholds that require the owner's permission to employ an on-chain block 152 when performing various operations and/or transactions, such as permitting temporary custody transfer of the on-chain block 152 to another distributed address of another entity's crypto wallet 120, and/or permitting access to media data stored within and/or referenced by the on-chain block 152. For example, the blockchain control system 107 can require the owner's consent whenever the blockchain control device 108 receives a custody transfer request for an on-chain block 152 from the blockchain control system 107, the event host system 101, and/or another user device 106 of the system 100. The blockchain control device 108 may execute the transaction on the blockchain 150 to reflect the change of custody after receiving a consent instruction from the NFT owner associated with the on-chain block 152. In some implementations, the blockchain control system 107 can require the owner's consent whenever the blockchain control device 108 receives a request to access an on-chain block 152 and/or media data associated with the on-chain block 152 from the blockchain control system 107, the event host system 101, and/or another user device 106 of the system 100. For example, the blockchain control device 108 can transmit a consent request notification to the user device 106 of the owner, and the user device 106 of the owner can generate a consent interface that prompts the owner to approve and/or deny the requested operation. The blockchain control device 108 can receive a consent instruction from the user device 106 of the owner indicating approval, and can proceed with the requested custody transfer and/or media access operation in response to receiving the consent instruction. In some implementations, one or more databases (e.g., the host database 104, the blockchain control database 110, etc.) of the system 100 can store consent instructions for each on-chain block 152, and the blockchain control device 108 and/or the event host system 101 can query the stored consent instructions to determine whether the consent requirement for a particular on-chain block 152 is satisfied prior to executing the requested operation.

As described above, the embodiment of FIG. 1A and FIG. 1B depicts the blockchain control device 108 performing the operations of generating, updating, and maintaining the blockchain 150. Embodiments, however, need not be as structured or localized as depicted in FIG. 1A and FIG. 1B. In some implementations, any number of computing devices of the system 100 can generate blocks and/or otherwise update the blockchain 150, provided such computing devices participate as nodes of the blockchain 150. For example, the event host device 102 can generate a new transaction block on the blockchain 150 to record an award distribution event, and/or a user device 106 can generate a transaction block to record a custody transfer of an on-chain block 152 from a first distributed address to a second distributed address. The blockchain control device 108 can validate the blocks generated by the event host device 102 and/or the user devices 106 according to a consensus protocol executed across the participating nodes of the blockchain 150.

The blockchain control database 110 can store various types of data and/or information used for performing the processes and tasks described herein. The blockchain control database 110 can be hosted by any computing device having computing hardware (e.g., processors, non-transitory memory, etc.) and software capable of hosting the information and executing queries received from the blockchain control device 108 and/or other components of the system 100. The data stored by the blockchain control database 110 may include on-chain blocks 152 and/or media data associated with the on-chain blocks 152, though some or all of the data may be stored in instances of the blockchain 150 and/or blocks at distributed nodes participating as nodes of the blockchain 150 (e.g., user devices 106).

In some implementations, the blockchain control database 110 can store a local instance of the blockchain 150 that replicates all or a portion of the distributed ledger state maintained across the participating nodes. For example, the blockchain control database 110 can maintain a full copy of the blockchain 150 including each transaction block, each on-chain block 152, and each associated hash value, such that the blockchain control device 108 can resolve queries for token identifiers, media data pointers, ownership records, and/or transaction histories without transmitting requests to external nodes of the blockchain 150. In some implementations, the blockchain control database 110 can store certain types of data that the blockchain control device 108 references when performing validation operations, custody transfer operations, and/or media retrieval operations, whereby the blockchain control database 110 can function as a source of truth for the system 100 with respect to the current state of the on-chain blocks 152 and their associated distributed addresses.

The blockchain 150 may include one or more on-chain executable programs (sometimes referred to as smart contracts) that include machine-readable software instructions stored on the blockchain 150 and executable by the event host device 102 and/or other devices of the system 100 (e.g., the blockchain control device 108, the user devices 106, etc.). In some implementations, when the event host device 102 executes software for conducting a randomized event session, the event host device 102 can invoke an on-chain executable program to transfer temporary possession of one or more on-chain blocks 152 from a second distributed address of a second crypto wallet 120b associated with an owner of the on-chain blocks 152 to a first distributed address of the first crypto wallet 120a that is stored on or accessible to the event host device 102. For example, the on-chain executable program can generate and/or update a transaction block of the blockchain 150 and/or other transaction data accessible to the devices of the system 100, where the transaction block and/or transaction data indicates that the event host device 102 incorporated the one or more on-chain blocks 152 into the randomized event session.

In some cases, the transaction block and/or transaction data can inhibit owners of the on-chain blocks 152 from conducting other transactions and/or operations using the on-chain blocks 152 while the randomized event session remains active. In some implementations, the on-chain executable program can store payment information associated with user accounts of the owner(s) of the on-chain blocks 152 within the transaction data, such that the event host device 102 can access the payment information when determining and/or distributing award values to the owner(s) of the on-chain blocks 152 upon completion of the randomized event session. When the event host device 102 terminates the randomized event session, the on-chain executable program can update a subsequent transaction block and/or transaction data on the blockchain 150 indicating that the one or more on-chain blocks 152 have been released from the second distributed address and may be employed in further transactions and/or operations by the owner(s). In some implementations, the on-chain executable program can execute the release of the on-chain blocks 152 in response to a triggering condition identified by the event host device 102, such as expiration of a predetermined session duration, receipt of a session termination instruction from an operator of the event host system 101, and/or detection that a user associated with the on-chain blocks 152 has exited a geographic region associated with the event host system 101.

FIG. 1B shows dataflow for the blockchain 150 implemented by computing devices participating as nodes of the blockchain 150, according to embodiments. The blockchain 150 may include any number of blocks representing various types of data. The blockchain 150 can comprise any number of blocks and/or on-chain blocks 152. The blockchain control device 108 and/or the event host device 102 may generate and/or mint the on-chain blocks 152 for distribution to, and use by, the various devices of the system 100. Any number of devices of the system 100 may mint on-chain blocks 152. For example, the blockchain control system 107 and the event host system 101 may be implemented as a single device and/or a single system that mints on-chain blocks 152. The event host device 102, the blockchain control device 108, and/or the user devices 106 may mint on-chain blocks 152, and/or may instruct the blockchain control device 108 to mint on-chain blocks 152. Each on-chain block 152 may include a unique token identifier (sometimes referred to as a “unique token ID”). The unique token ID can allow the blockchain control device 108 and/or other participating nodes of the blockchain 150 to locate, access, and/or retrieve the particular on-chain block 152 associated with the unique token ID. Each on-chain block 152 may include corresponding media data (e.g., image data, video data, audio data, etc.), and/or may include identifiers, addresses, and/or pointers to the corresponding media data. In some implementations, the media data can be embedded directly within the data structure of the on-chain block 152 on the blockchain 150, such that the blockchain control device 108 and/or the event host device 102 can parse the data structure to extract the media data without transmitting a retrieval request to an external storage location.

In some cases, the on-chain block 152 can include a content identifier and/or a pointer referencing media data stored via a decentralized storage protocol (e.g., IPFS), such that the blockchain control device 108 and/or the event host device 102 can resolve the content identifier and retrieve the media data from one or more distributed storage nodes of a decentralized storage network. In some cases, the on-chain block 152 can include a uniform resource locator (URL) linking to media data stored on a centralized storage server and/or a database (e.g., the blockchain control database 110, the host database 104, etc.), such that the blockchain control device 108 and/or the event host device 102 can transmit a network request to fetch the media data from the specified network location. In some cases, each on-chain block 152 can be associated with different media data. For example, a first on-chain block 152a can include a first media data (e.g., image data) of a particular dog, a second on-chain block 152b can include a second media data (e.g., image data) of a raven, and a third on-chain block 152c can include a third media data (e.g., image data) of a circle shape symbol.

The blockchain 150 may include entries of various types, such as blockchain blocks and on-chain blocks 152. A blockchain block can be a discrete unit of data entered to the blockchain 150. The block can contain various types of related data such that the block represents a certain type of information relevant to the blockchain 150. The block's data can include various cryptographic identifiers that associate the block with the blockchain 150. For example, the second on-chain block 152b can include a prior hash value of a prior first on-chain block 152a and a hash of the second on-chain block 152b. Similarly, the third on-chain block 152c can include the prior hash of the prior second on-chain block 152b and a hash of the third on-chain block 152c. The hash chaining is an example and does not limit potential data values and/or algorithms for the blocks. The on-chain blocks 152 can be a type of blockchain block that include more uniquely identifying data (e.g., unique token ID, media data, etc.) than other blockchain blocks, and may require more computationally expensive algorithmic operations to generate.

The on-chain blocks 152 may represent unique types of information (e.g., media data) and/or unique off-chain assets, because each on-chain block 152 can contain unique data entries and unique identifiers that render the on-chain blocks 152 non-fungible and not freely interchangeable. In some implementations, an on-chain block 152 may include pointers to storage memory locations containing actual values of media data. In some implementations, each on-chain block 152 can represent associated unique media and/or unique portions of the media. Each on-chain block 152 can contain, for example, unique token identifier information and unique information about the media. The on-chain blocks 152 may be generated using algorithms that take multiple cryptographic values (e.g., encryption key, digital signature, digital certificate, salt, seed, etc.) and unique media data to output one or more unique identifiers. The on-chain blocks 152 may contain unique data corresponding to owners of the on-chain blocks 152, and/or corresponding to user devices 106 of the owners, furthering the uniqueness of a particular block-entry to the blockchain 150. The on-chain blocks 152 are not feasibly interchangeable and/or exchangeable with another block or other type of entry on the blockchain 150 (e.g., NFT, token). The terms “block,” “NFT,” and “token” refer to potential types of entries of the blockchain 150 and do not limit potential embodiments.

Referring back to FIG. 1A, the event host system 101 can facilitate randomized event sessions using the on-chain blocks 152 of distributed addresses of crypto wallets 120. The event host device 102 can execute software programming related to executing randomized event sessions based on the on-chain blocks 152 and hosting the various services described herein. The event host device 102 can execute software programming related to distributing award values for the randomized event sessions based on the on-chain blocks 152. The event host device 102 can include any computing device having computing hardware (e.g., one or more processors, non-transitory memory, network interface controllers, etc.) and software for performing the various processes and tasks described herein. Non-limiting examples of the event host device 102 include servers, desktops, laptops, tablets, and the like. Although FIG. 1A shows one computing device as the event host device 102, the event host device 102 can include any number of computing devices. In some implementations, the event host device 102 can include a plurality of computing devices operating as a distributed computing cluster, where individual computing devices of the cluster execute respective portions of the randomized event session operations (e.g., one computing device can execute the randomization algorithm while another computing device can generate user interface data and/or determine award values). In some implementations, the event host device 102 can include one or more graphics processing units (GPUs) and/or one or more field-programmable gate arrays (FPGAs) that accelerate media rendering operations associated with generating the user interface 114 for the randomized event sessions.

The event host device 102 may host a cloud-based application for executing operations of the system 100, including software programming for hosting and executing operations for randomized event sessions, such as online and/or local gameplay using the on-chain blocks 152. In some implementations, the cloud-based application can be entirely web-based (e.g., a web portal accessible via a uniform resource locator), such that the computing devices (e.g., user devices 106) of the system 100 access the cloud-based application through a web browser executed at the respective computing device. For example, the event host device 102 (or another computing device of the blockchain control system 107) can execute webserver software that hosts a website providing a user interface 114 through which end-users view available randomized event sessions, select a session type (e.g., a slot machine game session, a roulette game session, a lottery game session, etc.), and/or initiate participation in the selected session.

In some implementations, the event host device 102 can publish the cloud-based application as a locally installable software package distributed to the computing devices of the system 100. For example, the event host device 102 can distribute an installer package to one or more user devices 106 via the network 112, and each user device 106 can execute the installed application locally to access services hosted by the event host device 102 without requiring a web browser. In operation, the user device 106 can execute the cloud-based application (e.g., a browser-based client, a locally installed software program, etc.) to establish a network session with the event host device 102, which can present the user interface 114 to an end-user and can receive input selections from the end-user corresponding to randomized event session operations, NFT contribution operations, and/or wager placement operations associated with the system 100.

The event host device 102 can access information about the on-chain blocks 152 by communicating with the blockchain 150 and/or the blockchain control device 108 via the network 112. In some implementations, the event host device 102 can transmit a query to the blockchain control device 108 to retrieve permission data associated with one or more on-chain blocks 152, where the permission data indicates whether an owner of a particular on-chain block 152 has granted authorization for the event host device 102 to incorporate media data of the particular on-chain block 152 into a randomized event session. For example, the event host device 102 can transmit, to the blockchain control device 108, a permission status request that includes a token identifier of a on-chain block 152, and the blockchain control device 108 can query the blockchain control database 110 for a stored consent instruction corresponding to the token identifier and return a permission status indication (e.g., granted, denied, pending, expired, etc.) to the event host device 102.

In some implementations, the event host device 102 can access the blockchain 150 to read transaction data and/or on-chain state data associated with the on-chain blocks 152, such as current ownership records, custody status indicators, and/or distributed address associations maintained on the blockchain 150. For example, the event host device 102 can read a transaction block of the blockchain 150 to determine whether a particular on-chain block 152 is currently held at a first distributed address of an owner's crypto wallet 120 or has been transferred to a second distributed address of the event host system 101 for use in an active randomized event session. The event host device 102 can condition subsequent operations (e.g., incorporation of media data into a randomized event session, execution of an on-chain executable program for award determination, etc.) on the permission data and/or the on-chain state data retrieved from the blockchain control device 108 and/or the blockchain 150. Additionally or alternatively, the event host device 102 may retrieve at least a portion of this information stored in the host database 104.

The event host device 102 can communicate with the blockchain oracle server 111 via the network 112 to obtain valuation data and/or other types of information about the on-chain blocks 152 when determining award values for users of the system 100. In some implementations, the event host device 102 can transmit a valuation query to the blockchain oracle server 111 that includes one or more token identifiers of the on-chain blocks 152 for which the event host device 102 requires current market data, pricing information, and/or metadata. For example, the event host device 102 can transmit a query specifying a unique token identifier of a particular on-chain block 152, and the blockchain oracle server 111 can retrieve a last traded market value, an average market value over a predetermined time period (e.g., 6 months, 12 months, etc.), a current listing price, and/or a floor price from one or more external data sources (e.g., public market platforms such as Rarible, NFT stars, Crypto. com, VeVe; third-party pricing application programming interfaces, decentralized exchange aggregators, etc.) and return the retrieved valuation data to the event host device 102.

The event host device 102 can receive the valuation data from the blockchain oracle server 111 and use the received valuation data as an input to a weighted value determination for each corresponding on-chain block 152, where the weighted value can influence the probability of selection assigned to the on-chain block 152 in a randomized event session, the award value determined for a user account upon successful selection of the on-chain block 152, and/or the fractional award value determined for an owner of the on-chain block 152. In some implementations, the event host device 102 can query the blockchain oracle server 111 at a predetermined interval (e.g., hourly, daily, per-session, etc.) to refresh the valuation data stored in the host database 104, such that weighted values used during randomized event sessions reflect current market conditions at the time of session execution. In some implementations, the blockchain oracle server 111 can aggregate data from multiple external data sources and return a composite valuation to the event host device 102, where the composite valuation can be a weighted average, a median, and/or a mode of the individual valuations retrieved from the respective external data sources. Additionally or alternatively, the event host device 102 may retrieve at least a portion of this information stored in the host database 104.

The user devices 106 may function as participating nodes of the blockchain 150. Each user device 106 can include any computing device having computing hardware (e.g., one or more processors, non-transitory memory, network interface controllers, display hardware, etc.) and software for performing the various processes and tasks described herein. Non-limiting examples of the user devices 106 include smart phones, servers, desktops, laptops, tablets, gaming consoles, and the like. The user devices 106 can have various configurations based upon the roles of the intended users. For example, the first user device 106a may access certain features of the cloud-based application (e.g., on-chain block 152 contribution features, placement auction bidding features, etc.) that are different from the features accessed by the second user device 106b and/or the third user device 106c (e.g., session initiation features, wager placement features, etc.). The user devices 106 can include, for example, gaming devices (e.g., a slot machine apparatus, a roulette apparatus, a video poker terminal, etc.) physically located within a casino hosting the event host system 101 and/or the blockchain control system 107. For instance, a first user device 106a can be a slot machine apparatus installed on a casino floor that displays the user interface 114 and receives wager inputs from a player, while a second user device 106b can be a mobile device carried by the same player and containing a crypto wallet 120 storing one or more on-chain blocks 152 available for incorporation into a randomized event session executed on the slot machine apparatus. A user device 106 can execute a locally installed application and/or a web browser to establish a network session with the event host device 102 and receive session state data, user interface 114 updates, and/or award notification data from the event host device 102 over the network 112.

The user devices 106 may display a user interface 114 for an output of the event host device 102. In some implementations, the user interface 114 can include one or more graphical elements that the event host device 102 populates upon executing the randomization algorithm. For example, in the illustration of FIG. 1A, three graphical elements (e.g., virtual reels of a virtual slot machine) are depicted on the user interface 114, though any number of graphical elements may be utilized depending on the type of randomized event session and/or the number of on-chain blocks 152 incorporated into the session. The event host device 102 can insert selected images corresponding to randomly identified on-chain blocks 152 into the graphical elements on the user interface 114.

In some cases, in a slot machine game session, a pay line extending through the graphical elements can determine whether the player is a winner, where each graphical element along the pay line displays media data of a respective on-chain block 152 selected by the randomization algorithm for a corresponding reel. For example, the event host device 102 can evaluate the on-chain blocks 152 displayed along the pay line to determine whether the media data and/or score values of the displayed on-chain blocks 152 satisfy a winning condition (e.g., three identical images aligned along the pay line, a cumulative score value exceeding a winning threshold, etc.), and an owner of an on-chain block 152 appearing in the pay line for a winning player can receive a fractional payout as described herein.

In some cases, in a roulette game session, a single graphical element can display the winning image corresponding to the on-chain block 152 selected by the randomization algorithm, and one or more additional graphical elements can depict nearby and/or other positions on the virtual roulette wheel. For example, the event host device 102 can generate the user interface 114 to display a primary graphical element containing the media data of the winning on-chain block 152 and secondary graphical elements containing media data of adjacent on-chain blocks 152 on the roulette wheel, such that the player can observe the outcome relative to neighboring positions.

In some cases, in a lottery game session, the graphical elements can depict winning images selected by the randomization algorithm, and a player can win depending on how many of the winning images match images identified on the player's lottery ticket. For example, the event host device 102 can compare the media data and/or token identifiers of on-chain blocks 152 displayed in the graphical elements against the media data and/or token identifiers associated with a player's lottery ticket selections, and the event host device 102 can determine the player's award value based on the number of matching on-chain blocks 152 between the displayed winning images and the player's ticket selections.

The event host device 102 can generate the user interface 114 based on media types determined at runtime. In some circumstances, the type of media data associated with each on-chain block 152 may not be known until the media data is extracted or retrieved from the on-chain block 152 and/or an off-chain storage location, the event host device 102 can determine the media type for each on-chain block 152 based on characteristics of the retrieved data, such as file headers, data structures, Multipurpose Internet Mail Extensions (MIME) types, and/or metadata embedded within the media data. In some implementations, the event host device 102 can classify media data into one or more media type categories, including static image data (e.g., JPEG, PNG, BMP, etc.), animated image data (e.g., GIF, APNG, etc.), video data (e.g., MP4, WebM, MOV, etc.), and/or audio data (e.g., MP3, WAV, AAC, etc.). For example, the event host device 102 can read a file header of retrieved media data, extract a MIME type string from the file header, and compare the extracted MIME type string against a stored mapping of MIME type strings to media type categories maintained in the host database 104.

Based on the identified media data type, the event host device 102 can configure the corresponding graphical elements of the user interface 114 to present the media according to the media type category. For static images, the event host device 102 can render the image data within a display element of the user interface 114 at a resolution and aspect ratio corresponding to the dimensions of the graphical element. For animated images and/or video data, the event host device 102 can configure playback timing, frame rates, and/or playback controls appropriate for the media format, such that the animated image and/or video data plays within the graphical element during the randomized event session. For audio data, the event host device 102 can configure audio output through audio interfaces of the user device 106 and can generate a visual representation (e.g., a waveform graphic, an album art placeholder, a speaker icon, etc.) within the corresponding graphical element of the user interface 114.

The event host device 102 can determine media types for on-chain blocks 152 incorporated into a randomized event session, where different on-chain blocks 152 in the session may have different media types, and the event host device 102 can configure each graphical element of the user interface 114 independently based on the media type of the corresponding on-chain block 152. The runtime media type determination enables the event host device 102 and/or other components of the system 100 to incorporate on-chain blocks 152 having various media data types into the randomized event session without requiring advance knowledge and/or manual configuration of the media formats prior to session execution.

In some embodiments, the user devices 106 comprise one or more peripheral interfaces for receiving validating inputs from receives. Non-limiting examples of the types of interfaces may include USB, PCI, RFID, NFC, or other technology for inputting validating inputs (e.g., digital certificate, digital signature) into a workstation using a physical device. In operation, the user device 106 transmits the validating input to other nodes of the system 100 to validate certain transaction operation or authenticate the particular user. Alternatively, the user device 106 executes the particular transaction operation locally and, as such, executes the particular validation or authentication operation locally using the validation input received from the user.

The event host device 102 can obtain media data associated with the on-chain blocks 152 to execute randomized event sessions based on permissions and/or other data associated with the on-chain blocks 152. The event host device 102 may allow a user of a user device 106 to create an account in the host database 104 for sharing and/or incorporating one or more on-chain blocks 152 in randomized event sessions. Each account may be associated with a crypto wallet having a distributed address on the blockchain 150. The event host device 102 may receive, from one or more user devices 106, one or more token IDs and a permission indication to use the on-chain blocks 152 and/or the media data associated with the on-chain blocks 152 in randomized event sessions. In some implementations, the event host device 102 can query the blockchain control system 107 and access on-chain blocks 152 referenced by the token IDs. For example, the event host device 102 can transmit, to the blockchain control system 107, an access request including token IDs of the on-chain blocks 152 to retrieve the on-chain blocks 152 and/or corresponding media data. In response to the access request, the event host device 102 may receive, from the blockchain control system 107 and/or from the blockchain 150, the requested on-chain blocks 152 and/or receive information and/or a cryptographic key to access the requested on-chain blocks 152.

In some implementations, where the on-chain blocks 152 include media data embedded directly within the on-chain data structure, the event host device 102 can obtain the media data directly from the on-chain blocks 152 by parsing the on-chain data structure to extract the embedded media data. In some implementations, where the on-chain blocks 152 include identifiers, addresses, and/or pointers to storage media storing the media data (e.g., a content identifier referencing a decentralized storage protocol, a uniform resource locator linking to a centralized storage server, etc.), the event host device 102 can obtain the media data from the storage media as indicated and/or referenced by the identifiers, addresses, and/or pointers in the on-chain blocks 152. For example, the event host device 102 can resolve a content identifier included in a on-chain block 152 to retrieve corresponding media data from one or more distributed storage nodes of a decentralized storage network, and/or the event host device 102 can transmit a network request to a centralized storage server specified by a uniform resource locator included in the on-chain block 152 to fetch the corresponding media data. The event host device 102 may store the obtained media data in the host database 104 for subsequent incorporation into one or more randomized event sessions.

The event host device 102 and/or other components of the system 100 (e.g., a user device 106) can include software programming for a media extraction engine and/or an on-chain media extraction executable program (collectively referred to as a media data extractor). The media data extractor can determine a storage format type for each on-chain block 152 and execute a corresponding retrieval operation to extract media data based on the determined storage format type. The media data extractor can categorize each on-chain block 152 into one of a plurality of storage format categories based on data contained within the on-chain block 152, such as a metadata field, a pointer type indicator, a content identifier prefix, and/or a uniform resource locator scheme. The plurality of storage format categories can include on-chain embedded media, decentralized storage referenced media, and/or centralized storage linked media.

For the on-chain embedded media category, the media data is stored directly within the data structure of the on-chain block 152 on the blockchain 150, and the media data extractor parses the blockchain data structure of the on-chain block 152 to extract the embedded media data without transmitting a retrieval request to an external storage location. For example, the media data extractor can read a byte-range of the on-chain block 152 specified by an offset value and a length value contained in a header field of the on-chain block 152, and extract the media data bytes from the read byte-range.

For the decentralized storage referenced media category, the on-chain block 152 includes a content identifier and/or a pointer to media data stored via a decentralized storage protocol (e.g., an IPFS content identifier, a content hash, etc.), and the media data extractor resolves the content identifier by querying one or more distributed storage nodes of a decentralized storage network to retrieve the media data associated with the content identifier. For example, the media data extractor can transmit a retrieval request containing the content identifier to a gateway node of the decentralized storage network, and the gateway node can locate and return the media data from whichever distributed storage node stores a copy of the media data corresponding to the content identifier.

For the centralized storage linked media category, the on-chain block 152 includes a uniform resource locator pointing to media data stored on a user device 106, a centralized storage server, and/or a database (e.g., the blockchain control database 110, the host database 104, etc.), and the media data extractor transmits a network request (e.g., an HTTP GET request, an HTTPS request, etc.) to the specified uniform resource locator to fetch the media data from the centralized storage location.

After extraction or retrieval of the media data, the media data extractor can convert the retrieved media data into a display-ready format compatible with the user interface 114 for incorporation into the user interface 114 during a randomized event session. The media data extractor can decode the retrieved media data from a source encoding format (e.g., a compressed binary format, a base64-encoded string, a hexadecimal-encoded byte sequence, etc.) into a decoded data representation that the event host device 102 can render within a graphical element of the user interface 114. In some cases, the decoded data representation can be a pixel buffer containing rasterized image data at a target resolution and color depth corresponding to the dimensions of the graphical element in the user interface 114. In some cases, the decoded data representation can be an audio sample buffer containing pulse-code modulation (PCM) samples at a target sample rate and bit depth corresponding to the audio output parameters of the user device 106 displaying the user interface 114. For example, the media data extractor can read a base64-encoded string from a retrieved on-chain block 152, decode the base64-encoded string into a raw byte array, determine an image codec type from a header portion of the raw byte array (e.g., PNG, JPEG, WebP, etc.), and invoke a corresponding codec decoder to generate a pixel buffer from the raw byte array. The media data extractor can store the decoded data representation in the host database 104 in association with the token identifier of the corresponding on-chain block 152, such that the event host device 102 can retrieve the display-ready media data from the host database 104 during execution of the randomized event session without repeating the decoding operation for each session iteration.

In operation, the event host device 102 can incorporate the extracted media data into randomized event sessions by assigning the media data to corresponding event positions of a session interface. For example, the event host device 102 can assign image data and/or video data stored by the host database 104 to corresponding slots of a slot machine game session and/or a roulette game session. The image data and/or video data may be presented at corresponding slots through the user interface 114. Each slot may be assigned to a corresponding value (e.g., a slot number), such that a slot and/or a corresponding on-chain block 152 can be identified by the corresponding value. In some implementations, the event host device 102 can determine weighted values of the on-chain blocks 152 (and/or weighted values of the associated media data) for setting and/or preparing the randomized event session. For example, the event host device 102 can query the blockchain control system 107, the blockchain oracle server 111, and/or a blockchain platform external to the system 100, such as a public market platform (e.g., Rarible, NFT stars, Crypto. com, VeVe, etc.), and determine the weighted value of each on-chain block 152 to be proportional to a last traded market value of the on-chain block 152, and/or an average market value of the on-chain block 152 over a predetermined time period (e.g., 6 months).

The event host device 102 can determine a type of digital media of the on-chain block 152 and assign a corresponding value for the determined type as the weighted value of the on-chain block 152. For example, types of digital media can include image data type, video data type, and/or audio data type, and the types of digital media may be categorized according to subject and/or content in the digital media data (e.g., animal image type, symbol image type, automobile image type, celebrity image type, cartoon image type, etc.). In some implementations, the event host device 102 can determine the weighted value of an on-chain block 152 to be proportional to an average market value of on-chain blocks 152 owned by the same owner and/or associated with a same distributed address of a crypto wallet.

The event host device 102 may adjust a probability of success in the randomized event session according to the weighted values of the on-chain blocks 152 and/or the weighted values of the associated media data. The probability of success for a given on-chain block 152 may be inversely proportional to the weighted value of the on-chain block 152 and/or the media data of the on-chain block 152. In some implementations, the event host device 102 can allocate a higher-weighted-value on-chain block 152 to a fewer number of event positions (e.g., slots, reel positions, roulette pockets, etc.) than a number of event positions allocated for a lower-weighted-value on-chain block 152, such that the selection probability for the higher-weighted-value on-chain block 152 is lower than the selection probability for the lower-weighted-value on-chain block 152. For example, where a first on-chain block 152 associated with a first image of a particular dog has a weighted value greater than a weighted value of a second on-chain block 152 associated with a second image of a raven, the event host device 102 can assign the first image of the dog to two event positions of a slot machine game session and/or a roulette game session, and can assign the second image of the raven to five event positions of the same session. The probability of winning the slot machine game session and/or the roulette game session with the first image of the dog may therefore be lower than the probability of winning the slot machine game session and/or the roulette game session with the second image of the raven.

In some implementations, the event host device 102 can compute the number of event positions for each on-chain block 152 by dividing a total number of available event positions by a normalization factor derived from the weighted values of all on-chain blocks 152 incorporated into the randomized event session, and rounding the result to an integer value. The event host device 102 can store the computed event position allocations in the host database 104 in association with the corresponding token identifiers of the on-chain blocks 152, such that the randomization algorithm can reference the stored allocations when generating random values during execution of the randomized event session.

The event host device 102 can receive, from a session user device, a request to initiate and/or participate in a randomized event session. A session user device may be a user device 106 operated by an owner of the user device 106, and/or a shared computing device (e.g., a kiosk, a public terminal, a gaming machine on a casino floor, etc.) that is publicly available and operated by the same entity that operates the event host system 101. In some implementations, the user of the session user device may be an owner of one or more on-chain blocks 152, though the user of the session user device need not own any on-chain block 152 to initiate and/or participate in a randomized event session.

The request may include a distributed address of a crypto wallet associated with the user of the session user device, account information (e.g., credit account information, bank account information, debit card information, etc.) of the user of the session user device, and/or an amount of wager and/or an amount of risk to participate in the randomized event session. The amount of wager may be predetermined by the event host device 102 and/or selected by the user through the user interface 114 rendered on the session user device. The distributed address may be an address of a crypto wallet maintained by the blockchain control system 107 and/or a crypto wallet maintained by a different blockchain control system external to the system 100.

The event host device 102 can query the blockchain control system 107 to verify whether the distributed address is valid, and whether sufficient funds (e.g., crypto-assets, fungible tokens, stablecoins, etc.) exist at the distributed address to satisfy the amount of wager. For example, the event host device 102 can transmit a balance verification request to the blockchain control device 108 that includes the distributed address and the amount of wager, and the blockchain control device 108 can query the blockchain 150 to determine a current balance at the distributed address and return a verification response indicating whether the current balance is greater than and/or equal to the amount of wager. Additionally or alternatively, the event host device 102 can query a third-party device operated by a financial institution (e.g., a bank server, a credit card issuer server, a payment processor, etc.) to verify whether the user account is valid and whether sufficient funds exist for the user account. In some implementations, the request includes a user-selection in the randomized event session. For example, in a roulette game session, the user may select one or more slots and/or event positions corresponding to a particular digital media and/or image of a on-chain block 152 on which the user places a wager.

After verifying that the user has sufficient funds to participate in the randomized event session, the event host device 102 may allow the user device 106 to participate in randomized event sessions. In some implementations, the event host device 102 can execute the randomized event session incorporating media data of the on-chain blocks 152. The event host device 102 can execute one or more randomization algorithms that randomly identify and/or select a token ID from a set of token IDs corresponding to available slots in the randomized event session. For example, the randomization algorithm can generate one or more random values, where the one or more random values correspond to one or more slots and/or token IDs assigned to event positions of the user interface 114.

In some cases, the event host device 102 can determine the outcome of the randomized event session by determining whether the randomization algorithm generated a particular pattern and/or sequence of random values. For example, in a slot machine game session, the event host device 102 can determine that the user is successful in the randomized event session when three identical random values are generated across three respective virtual reels of the slot machine game session, where each identical random value corresponds to the same token ID and/or the same media data of an on-chain block 152.

In some cases, the event host device 102 can determine the outcome of the randomized event session by comparing a random value generated by the randomization algorithm against a slot number of an image and/or an on-chain block 152 selected by the user via the user interface 114. For instance, in a roulette game session, the event host device 102 can determine that the user is successful in the randomized event session when the random value generated matches a slot value and/or a slot number associated with the image and/or the on-chain block 152 that the user selected prior to execution of the randomization algorithm.

The event host device 102 can generate and transmit result information indicating an outcome of the randomized event session to the user device 106 to notify the user. The result information can include an indication of the randomly selected token ID, the media data of the corresponding on-chain block 152, and/or the award value determined for the user account associated with the user device 106. In some implementations, the result information can include a session outcome indicator specifying whether the user account associated with the user device 106 achieved a successful outcome (e.g., a winning condition satisfied, a score threshold exceeded, a matching pattern detected, etc.) and/or an unsuccessful outcome in the randomized event session. For example, the event host device 102 can generate a result data structure containing the token identifier of the randomly selected on-chain block 152, a reference to the media data displayed in the corresponding graphical element of the user interface 114, the first award value determined for the user account, and/or the second award value determined for an owner of the selected on-chain block 152.

The event host device 102 can transmit the result information to the user device 106 via the network 112, and the user device 106 can render a result display on the user interface 114 that presents the outcome of the randomized event session to the user. In some implementations, the event host device 102 can transmit the result information to the user device 106 in response to execution of the randomization algorithm completing and the event host device 102 determining the outcome, such that the user device 106 receives the result information after the event host device 102 updates the user interface 114 with the media data of the identified on-chain block 152.

The event host device 102 can synchronize the update of the user interface 114 and event session state data with the output of the randomization algorithm. The event host device 102 can maintain a synchronization state data structure that stores a mapping between the randomization output (e.g., the randomly selected token IDs, slot values, and/or reel position values generated by the randomization algorithm) and corresponding visual element identifiers of the user interface 114 that display media data of the on-chain blocks 152. Upon execution of the randomization algorithm, the event host device 102 can generate a synchronization signal that triggers the user interface 114 to replace a current set of displayed media data with media data of the on-chain blocks 152 corresponding to the randomization output. For example, the event host device 102 can generate the synchronization signal as a display update instruction containing the token identifiers of the randomly selected on-chain blocks 152 and/or references to display-ready media data stored in the host database 104 for each randomly selected on-chain block 152, and can transmit the display update instruction to the user device 106 rendering the user interface 114.

The event host device 102 can verify that the visual elements rendered on the user interface 114 correspond to the randomization output by comparing the token identifiers and/or media references associated with the displayed visual elements against the token identifiers and/or media references indicated in the randomization output. In some implementations, if the event host device 102 detects a discrepancy between the randomization output and the displayed visual elements (e.g., a mismatch between a token identifier in the randomization output and a token identifier associated with a graphical element of the user interface 114), the event host device 102 can regenerate the user interface 114 using the media data corresponding to the randomization output and/or transmit corrected display data to the user device 106. The synchronization between the randomization output and the user interface 114 can prevent inconsistencies between the distributed ledger state of the blockchain 150 (e.g., a transaction block recording the randomization result on the blockchain 150) and the visual output presented to the user on the user interface 114.

In some embodiments, the event host device 102 coordinates multiplayer online gambling sessions by establishing and maintaining concurrent network connections with a plurality of user devices 106. Each user device 106 may be operated by a different participant in the multiplayer gambling session, where participants may be geographically distributed across different network locations with varying network latencies and device display capabilities. The event host device 102 can maintain a session state data structure that tracks a current state of the multiplayer gambling session, including the on-chain blocks 152 incorporated into the session, a current randomization state, wagers placed by each participant, and positions and/or selections made by each participant.

The event host device 102 can broadcast session state updates to all connected user devices 106 to provide consistent game states across the multiplayer gambling session, such that all participants observe the same NFT media elements and the same randomization outcomes regardless of the respective network location of each user device 106. For example, the event host device 102 can generate a session state update message containing a current randomization output (e.g., the token identifiers of randomly selected on-chain blocks 152, the corresponding media data references, the determined award values, etc.) and transmit the session state update message to each connected user device 106 via the network 112.

Optionally, the event host device 102 can implement latency compensation operations to account for varying network delays between the event host device 102 and different user devices 106. For example, the event host device 102 can determine a round-trip time value for each connected user device 106 by transmitting a timing probe message to the user device 106 and measuring a duration between transmission of the timing probe message and receipt of a corresponding timing response message from the user device 106. The event host device 102 can use the determined round-trip time values to stagger transmission of session state update messages to respective user devices 106, such that participants at different user devices 106 perceive simultaneous game state transitions despite differences in network round-trip times between the event host device 102 and the respective user devices 106.

In some implementations, the multiplayer gambling session can include a shared gaming pool to which multiple participants contribute on-chain blocks 152. The event host device 102 can receive contribution indications from multiple user devices 106, where each contribution indication identifies one or more on-chain blocks 152 that the contributing participant authorizes for use in the shared gaming pool. For example, a contribution indication can include a token identifier of an on-chain block 152, a distributed address of a crypto wallet from which the on-chain block 152 originates, and/or a permission flag indicating that the contributing participant grants authorization for the event host device 102 to incorporate media data of the on-chain block 152 into the user interface 114 for the duration of the multiplayer gambling session.

The event host device 102 can aggregate the contributed on-chain blocks 152 into a combined pool data structure stored in the host database 104, where the combined pool data structure associates each token identifier of a contributed on-chain block 152 with the distributed address of the contributing participant and/or a user account identifier of the contributing participant. The event host device 102 can incorporate the media data of the pooled on-chain blocks 152 into the user interface 114 presented to all participants of the multiplayer gambling session, such that the user interface 114 displays media data extracted from on-chain blocks 152 contributed by different participants across the event positions of the randomized event session. During the randomized event session, participants may wager on outcomes involving on-chain blocks 152 contributed by the respective participant and/or by other participants in the shared gaming pool. The event host device 102 can maintain ownership association records in the combined pool data structure that map each on-chain block 152 in the shared gaming pool to the corresponding contributing participant, such that the event host device 102 can identify the owner of each randomly selected on-chain block 152 when determining fractional award values to allocate to owners of on-chain blocks 152 whose media data was randomly selected and/or contributed to a winning outcome in the multiplayer gambling session.

In some embodiments, a user device 106 may execute the randomized event session incorporating media data of the on-chain blocks 152. The event host device 102 may transmit, to the user device 106, event configuration information indicating how the randomized event session is arranged and/or configured. The event configuration information can include a number of event positions, locations of event positions for corresponding images, and/or a probability of success for each event position and/or image. Based on the event configuration information received from the event host device 102, the user device 106 may set up and execute the randomized event session locally without transmitting intermediate requests to the event host device 102 during session execution. For example, the user device 106 may generate random values through the randomization algorithm and determine the outcome of the randomized event session based on the generated random values.

Additionally or alternatively, in some embodiments, the user device 106 can determine the outcome of the randomized event session by determining whether the randomization algorithm generated a particular pattern and/or sequence of random values. For example, in a slot machine game session, the user device 106 can determine that the user achieved a successful outcome when three identical random values are generated across three respective virtual reels, where each identical random value corresponds to the same token identifier and/or the same media data of an on-chain block 152. In some implementations, the user device 106 can determine the outcome of the randomized event session by comparing (i) a random value generated by the randomization algorithm and (ii) a slot number of an image and/or an on-chain block 152 selected by the user via the user interface 114. For example, in a roulette game session, the user device 106 can determine that the user achieved a successful outcome when the generated random value matches a pocket value and/or a pocket number associated with the image and/or the on-chain block 152 that the user selected prior to execution of the randomization algorithm.

The user device 106 may execute multiple randomized event sessions based on the event configuration information without requesting updated configuration data from the event host device 102 between successive sessions. The user device 106 may generate and transmit result information indicating the outcome of the randomized event session to the event host device 102 via the network 112. In some implementations, the user device 106 can transmit the result information after completing each randomized event session, after completing a predetermined number of event sessions (e.g., 5 sessions, 10 sessions, 50 sessions, etc.), and/or at a periodic interval (e.g., every 30 minutes, every hour, etc.). Executing the randomized event session at the user device 106 can conserve computational resources of the event host device 102 by offloading random value generation and outcome determination operations to the user device 106. The outcome of the randomized event session may be presented to the user on the user interface 114 with reduced latency, because the user device 106 can render the outcome on the user interface 114 upon local determination of the outcome without waiting for result information from the event host device 102 over the network 112.

The event host device 102 can determine an award value for a user account associated with the session user device that participated in and/or initiated the randomized event session based on the on-chain blocks 152. The award value may correspond to and/or may be proportional to the amount of wager included in the request received from the session user device. The event host device 102 may provide different amounts of award for a successful outcome in the randomized event session to the session user device, according to weighted values of the on-chain blocks 152 and/or weighted values of media data associated with the on-chain blocks 152. The event host device 102 can determine the amount of award for the successful outcome in the randomized event session according to the adjusted probability of success assigned to the randomly selected on-chain block 152. For example, the event host device 102 can assign a larger amount of award when the user wins the slot machine game session and/or the roulette game session with an image having a lower probability of success, and can assign a smaller amount of award when the user wins the slot machine game session and/or the roulette game session with an image having a higher probability of success.

In some implementations, the event host device 102 can determine the award value by multiplying the amount of wager in the request by a coefficient that is inversely proportional to the probability of success for the corresponding on-chain block 152, such that an on-chain block 152 allocated to fewer event positions (e.g., a lower selection probability) yields a larger award value relative to the amount of wager than an on-chain block 152 allocated to a greater number of event positions (e.g., a higher selection probability). In some implementations, the event host device 102 can determine the award value by multiplying the amount of wager in the request by the weighted value of the randomly selected on-chain block 152.

The event host device 102 can generate an award notification indicating the determined award value for the session user device. The award notification can include the first award value, a payment account identifier associated with the user account, and/or a transaction authorization instruction directing a recipient system to execute a payment operation corresponding to the first award value. In some implementations, the event host device 102 can transmit the award notification to the blockchain control system 107 to authorize payment of the award value to a distributed address of a crypto wallet associated with the user account. For example, the event host device 102 can generate the award notification as a transaction request data structure containing the distributed address of the user's crypto wallet, the first award value denominated in a crypto-asset unit (e.g., a fungible token, a stablecoin, an Ether value, etc.), and a reference to the on-chain executable program that validates and executes the transfer on the blockchain 150.

In some implementations, the event host device 102 can transmit the award notification to a third-party device operated by a financial institution (e.g., a bank server, a credit card issuer server, a payment processor, etc.) to authorize payment of the award value to a fiat-currency payment account associated with the user account. For example, the event host device 102 can generate the award notification as a payment authorization message containing a routing number, an account number, and/or a card token associated with the user account, together with the first award value denominated in a fiat currency (e.g., United States dollars, Euros, British pounds, etc.), and can transmit the payment authorization message to the third-party device via a secure network connection over the network 112.

The event host device 102 can retrieve the payment account identifier from the host database 104 by querying the host database 104 with a user account identifier associated with the session user device. In some implementations, where the payment account identifier for the user account is not available in the host database 104 and/or is invalid (e.g., expired, revoked, associated with a closed account, etc.), the event host device 102 can transmit an instruction to the user device 106 associated with the user account to generate a user interface 114 that prompts the user to input payment account information, and the event host device 102 can receive the input payment account information from the user device 106 and store the received payment account information in the host database 104 in association with the user account identifier.

The event host device 102 can determine and distribute award values to user accounts associated with owner-users of each of the winning on-chain blocks 152 from which the event host device 102 extracted media data and incorporated into the randomized event session, when the event host device 102 determines that the token IDs of those on-chain blocks 152 are part of the winning result generated by the randomized event algorithm. In some implementations, the event host device 102 can determine an amount of award for an owner and/or an account associated with an on-chain block 152 to be a fraction (e.g., a predetermined percentage, a variable percentage derived from a weighted value of the on-chain block 152, etc.) of the award allocated to the user that initiated and/or participated in the randomized event session. For example, the event host device 102 can multiply the first award value determined for the session user device by a fractional coefficient stored in the host database 104 in association with the token identifier of the on-chain block 152, where the fractional coefficient can be a fixed value (e.g., 5%, 10%, 15%, etc.) and/or a variable value that the event host device 102 computes based on the weighted value of the on-chain block 152 relative to weighted values of other on-chain blocks 152 incorporated into the randomized event session.

The event host device 102 can generate an award notification indicating the determined award for each user device 106 associated with the owner of the on-chain blocks 152, and can transmit the award notification to the blockchain control system 107 and/or a third-party device operated by a financial institution (e.g., a bank server, a credit card issuer server, a payment processor, etc.) to authorize payment of the award to the payment account associated with the owner of the on-chain blocks 152. In some implementations, the event host device 102 can generate a separate award notification for each owner of each winning on-chain block 152 that was randomly selected and/or that contributed to a successful outcome in the randomized event session, such that multiple owners can receive respective fractional award payments from a single randomization event when multiple on-chain blocks 152 contributed to the winning outcome. For example, in a slot machine game session where three on-chain blocks 152 owned by three different owners are displayed along a pay line for a winning player, the event host device 102 can generate three respective award notifications, each containing a fractional award value computed for the corresponding owner based on the weighted value of the respective on-chain block 152. The event host device 102 can transmit each award notification to the blockchain control system 107 and/or the third-party device associated with the corresponding payment account to authorize payment of the fractional award to the distributed address and/or the fiat-currency payment account of the respective owner.

In some embodiments involving multiplayer gambling sessions, the event host device 102 can determine and distribute awards to multiple participants and multiple NFT owners based on a single randomization outcome. When a randomization outcome in a multiplayer session results in one or more winning participants, the event host device 102 can determine a first award value for each winning participant based on the participant's wager amount and characteristics of the randomly selected on-chain blocks 152 (e.g., weighted values, probability of selection, media type, etc.). The event host device 102 can further determine fractional award values for owners of on-chain blocks 152 whose media data was randomly selected and/or contributed to the winning outcome.

In some implementations, the fractional award value for each NFT owner can be calculated as a predetermined percentage of the first award value distributed to winning participants. For example, the event host device 102 can multiply the first award value determined for a winning participant by a fractional coefficient (e.g., 5%, 10%, 15%, etc.) stored in the host database 104 in association with the token identifier of the corresponding on-chain block 152, and can assign the resulting product as the fractional award value for the owner of that on-chain block 152.

In multiplayer sessions with shared NFT gaming pools, multiple NFT owners may receive fractional awards from a single randomization event when the randomly selected outcome includes on-chain blocks 152 contributed by different participants. For example, in a competitive slots session where three on-chain blocks 152 owned by three different owners are selected for a winning participant's virtual reels, the event host device 102 can compute three respective fractional award values based on the weighted values of the respective on-chain blocks 152 and the first award value determined for the winning participant. The event host device 102 can generate award notifications for each winning participant and each NFT owner entitled to a fractional award, and can transmit the award notifications to the blockchain control system 107 and/or third-party payment systems via the network 112 to authorize the respective payments.

In some embodiments, the event host device 102 may conduct a placement auction allowing NFT owner-users to bid for opportunities to include the owners' on-chain blocks 152 in randomization events. The event host device 102 can receive bids from the user devices 106 of the NFT owners and can incorporate the winning owner's on-chain block 152 into the randomized event sessions. In operation, the user devices 106 of the owners can access an auction event session hosted by the event host device 102, during which the event host device 102 receives and evaluates bids according to preconfigured rules stored in the host database 104. The owners can enter the bids via an auction interface that instructs the user devices 106 to submit the bids to the event host device 102. The event host device 102 can identify the winning owner having the winning bid (e.g., highest dollar amount, highest crypto-asset amount, etc.) and can determine one or more on-chain blocks 152 of the winning owner to incorporate into a current and/or future randomized event session. In some implementations, the event host device 102 can determine the on-chain block 152 of the winning owner based upon an indicator received with the bid. For example, the bid data structure transmitted from the user device 106 of the winning owner can include a token identifier field specifying which on-chain block 152 the owner offers for incorporation into the randomized event session. In some implementations, the event host device 102 can determine the on-chain block 152 of the winning owner according to a selection input received from the user device 106 after the event host device 102 identifies the winning bid. For example, the event host device 102 can transmit a selection prompt to the user device 106 of the winning owner, and the user device 106 can return a selection input specifying one or more token identifiers of on-chain blocks 152 that the owner designates for inclusion in the randomized event session.

When establishing and hosting a randomized event session, the event host device 102 can select a subset of the on-chain blocks 152 to incorporate into the randomized event session according to any number of selection configurations. In some implementations, in embodiments involving the placement auction, the event host device 102 can select the on-chain blocks 152 of winning owners identified during the auction. In some implementations, the event host device 102 may randomly select the on-chain blocks 152 from the set of available on-chain blocks 152 for which the event host device 102 received permission indications. For example, the event host device 102 can execute a random selection algorithm over the set of token identifiers stored in the host database 104 to identify a subset of on-chain blocks 152 having a count equal to a number of available event positions in the randomized event session (e.g., 37 positions for a roulette game session, 10 positions per reel for a slot machine game session, etc.). In some implementations, the event host device 102 can change the on-chain blocks 152 incorporated into randomized event sessions at a periodic interval (e.g., every 10 sessions, every day, etc.), such that different on-chain blocks 152 can be utilized in different randomized event sessions over time.

In some embodiments, a first user device 106a can be a gaming machine (e.g., a roulette apparatus, a slot machine apparatus, a video poker terminal, etc.) physically located within a casino, and a second user device 106b can be a mobile device containing a crypto wallet of the user. The user may be a player, an NFT owner, or both. Where the user is both the player and the NFT owner, the first user device 106a and/or the event host device 102 can access the user's crypto wallet to identify the on-chain blocks 152 available to include in the user interface 114 during gameplay. In some implementations, the event host device 102 may access the crypto wallet according to one or more triggering conditions. For example, the event host device 102 may detect proximity of the second user device 106b based upon a geo-fence and/or a geographic identifier received from the second user device 106b indicating that the second user device 106b is within a threshold distance from the first user device 106a (e.g., within the casino, on the casino floor, within a predetermined number of meters from the first user device 106a, etc.). In some implementations, the event host device 102 may determine that the second user device 106b entered the casino upon detecting that the second user device 106b established a wireless connection (e.g., Wi-Fi, Bluetooth, NFC, etc.) with the first user device 106a, a wireless access point, and/or a wireless beacon associated with the casino.

The event host device 102 can access software of the second user device 106b and can transmit a request to the second user device 106b to provide one or more on-chain blocks 152 of the crypto wallet. The second user device 106b and/or the event host device 102 can execute programming of an on-chain executable program to generate a transaction block and/or transaction data on the blockchain 150 indicating that the one or more on-chain blocks 152 are temporarily transferred to a distributed address of a crypto wallet accessible to the event host device 102. In some implementations, the user may interact with software of the second user device 106b to select which on-chain blocks 152 are available to the event host device 102 for gameplay. For example, the second user device 106b can generate a selection interface displaying the on-chain blocks 152 stored in the user's crypto wallet 120, and the user can provide selection inputs indicating which on-chain blocks 152 to offer for incorporation into the randomized event session on the first user device 106a. The second user device 106b can transmit the selection inputs to the event host device 102, and the event host device 102 can extract and incorporate media data of the selected on-chain blocks 152 into the user interface 114 (e.g., gameplay graphical user interface) displayed on the first user device 106a. The on-chain blocks 152 may be withdrawn from the randomized event session upon the event host device 102 detecting that the user has left the casino. For example, the event host device 102 can detect that the second user device 106b moved beyond the threshold distance from the first user device 106a and/or that the wireless connection between the second user device 106b and the wireless access point terminated, and the event host device 102 can invoke the on-chain executable program to transfer the on-chain blocks 152 from the first distributed address of the first crypto wallet 120a accessible to the event host device 102 back to the second distributed address of the user's second crypto wallet 120b on the second user device 106b.

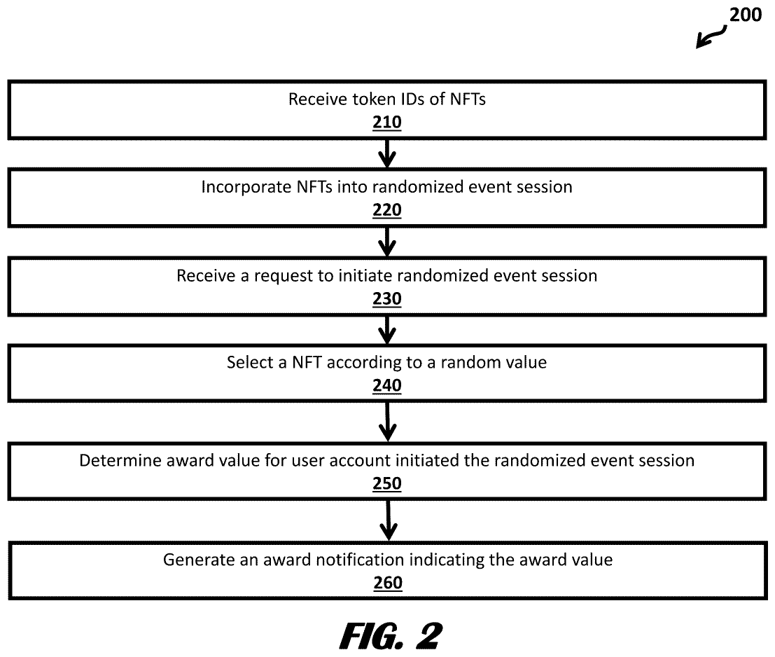

FIG. 2 is a flowchart depicting operations of a method 200 for executing a randomized event session implementing on-chain blocks (e.g., NFTs, tokens) of a distributed ledger (e.g., blockchain), according to an embodiment. Embodiments may include additional, fewer, or different operations than those described in the method 200. The method 200 can be performed by a server (e.g., an event host device 102 of the event host system 101) executing machine-readable software code associated with a distributed ledger ecosystem of participating nodes, though one or more computing devices and/or processors may perform the various operations described in FIG. 2. In some implementations, one or more steps of the method 200 can be performed by a user device 106 operated by a user. For example, a user device 106 can execute a locally installed application that performs the randomization algorithm and/or the outcome determination operations of the method 200 based on event configuration information received from the server (e.g., event host device 102). In some implementations, one or more steps of the method 200 can be performed by a shared computing device (e.g., a kiosk, a public terminal, a gaming machine on a casino floor, etc.) that is publicly available and operated by the same entity that operates the event host system.

In operation 210, the server receives block identifiers (block IDs) of on-chain blocks from one or more user devices operated by one or more owners and/or custodians of on-chain blocks. Each on-chain block may be identified by a unique block ID (e.g., a unique token ID, a content hash, a minting transaction identifier, etc.). The server may receive, from the one or more user devices, one or more block IDs and a permission indication to utilize the on-chain blocks and/or media data associated with the on-chain blocks in randomized event sessions. In some implementations, the permission indication can be a binary authorization flag transmitted with the block IDs indicating that the owner grants the server access to incorporate media data of the corresponding on-chain blocks into one or more randomized event sessions. In some implementations, the permission indication can be a scope-limited authorization specifying a duration, a number of sessions, and/or a set of session types (e.g., slot machine game sessions, roulette game sessions, lottery game sessions, etc.) for which the owner authorizes use of the on-chain blocks.

The server may query a blockchain control system (e.g., the blockchain control system 107) and access the on-chain blocks referenced by the block IDs. For example, the server can transmit, to the blockchain control system, an access request including the block IDs of the on-chain blocks to retrieve the on-chain blocks and/or corresponding media data from a distributed ledger (e.g., the blockchain 150). In response to the access request, the server may receive, from the blockchain control system and/or from the distributed ledger, the requested on-chain blocks and/or a cryptographic key granting the server read access to the requested on-chain blocks at corresponding distributed addresses.

In some implementations, the server can determine a storage format type and storage media location for each received on-chain block to select a retrieval operation for extracting the media data from the on-chain block. Where the on-chain blocks encompass media data embedded directly within an on-chain data structure, the server can parse the on-chain data structure to obtain the media data directly from the on-chain blocks without transmitting a retrieval request to an external storage location. Where the on-chain blocks include identifiers, addresses, and/or pointers referencing a storage medium storing media (e.g., a content identifier for a decentralized storage protocol, a uniform resource locator for a centralized storage server, etc.), the server may obtain the media data from the storage medium as indicated and/or referenced by the identifiers, addresses, and/or pointers in the on-chain blocks. For example, the server can resolve a content identifier included in an on-chain block to retrieve media data from one or more distributed storage nodes of a decentralized storage network, and/or the server can transmit an HTTP request to a centralized storage server specified by a uniform resource locator included in the on-chain block to fetch the media data from the specified network location. The server may store the obtained media data in a host database (e.g., the host database 104) in association with the corresponding block IDs for subsequent incorporation into randomized event sessions.

In some implementations, the server may receive block IDs from a user device (e.g., the user device 106) operated by a user who intends to participate in a randomized event session as a player-user and/or contribute on-chain blocks to the randomized event session as an owner-user. The server can transmit an incorporation request to the user device to incorporate one or more on-chain blocks associated with the user into the randomized event session. In response to the incorporation request, the user device and/or the server can determine whether a distributed address (e.g., a crypto wallet address) of the user contains the block IDs and/or any other addressing identifier for the on-chain blocks. For example, the user device can query the distributed address of the user by transmitting a balance inquiry to a blockchain control system (e.g., the blockchain control system 107) and/or by reading a local copy of ledger state data stored on the user device, and the blockchain control system and/or the user device can return a list of block IDs currently held at the distributed address.

In some implementations, the user device can generate an approval request notification and/or an approval interface that prompts the user of the user device to indicate which on-chain blocks the user offers to the server for generating the randomized event session. For example, the approval interface can display a selectable list of on-chain blocks available in the user's distributed address, where each selectable entry includes a thumbnail of the media data and/or a block ID of the corresponding on-chain block, and the user can provide selection inputs designating one or more on-chain blocks from the selectable list for incorporation into the randomized event session. The server or user device can contain and/or remotely access the distributed address of a crypto wallet of the user to query for the on-chain blocks designated by the user's selection inputs. If the distributed address includes the block IDs and/or addresses for the designated on-chain blocks, the user device can update an operational event block and/or transaction data of the blockchain (e.g., the blockchain 150) to indicate that the designated on-chain blocks are in temporary control of a distributed address accessible to the server (e.g., a distributed address of a crypto wallet associated with an event host device such as the event host device 102).

In operation 220, the server incorporates on-chain blocks into randomized event sessions by assigning extracted media data to event positions of a session interface. For example, the server can assign image data and/or video data stored by a host database (e.g., the host database 104) to corresponding reels of a slot machine game session and/or corresponding positions of a roulette game session. The image data and/or video data may be presented at corresponding reels and/or positions through a user interface (e.g., the user interface 114), whether rendered on a user device such as a mobile phone and/or a slot machine in a casino. Each reel and/or position may be assigned to a corresponding value (e.g., a reel number, a slot number, a pocket number, etc.), such that a reel and/or a corresponding on-chain block can be identified by the corresponding value. In some implementations, the server can determine weighted values of on-chain blocks (and/or weighted values of the associated media data) for setting and/or preparing the randomized event session.

For each on-chain block, the server may query a blockchain control system (e.g., the blockchain control system 107), an external value feed computing device (e.g., the blockchain oracle server 111), and/or a public market platform (e.g., Rarible, NFT stars, Crypto. com, VeVe, etc.), and determine the weighted value of the on-chain block to be proportional to a last traded market value of the on-chain block, and/or an average market value of the on-chain block over a predetermined time period (e.g., 6 months, 12 months, etc.). In some implementations, the server may determine a type of media of the media data of the on-chain block and assign a corresponding value for the determined type as the weighted value of the on-chain block. Examples of types of digital media include image data type, video data type, and/or audio data type. The types of digital media may be categorized according to subject and/or content in the digital media data (e.g., animal image type, symbol image type, automobile image type, celebrity image type, cartoon image type, etc.). The server may determine the weighted value of the on-chain block to be proportional to an average market value of on-chain blocks owned by the same owner and/or associated with the same distributed address of a crypto wallet.

In some implementations, the server can select, from a set of on-chain blocks, a subset of on-chain blocks to incorporate into the randomized event session. For example, the number of event positions available in a roulette game session may be limited to 37, and the server can select 37 on-chain blocks from a larger pool of potential on-chain blocks (e.g., thousands of on-chain blocks for which permission indications have been received) to incorporate into the roulette game session. The server may select the subset of on-chain blocks randomly and/or according to preconfigured selection rules (e.g., placement auction bids, weighted value thresholds, owner-specified availability windows, etc.).

In some implementations, the server may update or change the on-chain blocks incorporated into randomized event sessions at a periodic interval (e.g., every 10 sessions, every day, every week, etc.), such that different on-chain blocks can be utilized in different randomized event sessions over time. For example, the server can maintain a rotation schedule stored in a host database (e.g., the host database 104) that specifies a set of block identifiers for each rotation period, and the server can replace the current set of on-chain blocks with a subsequent set of on-chain blocks from the rotation schedule upon expiration of the rotation period. In some implementations, the server can receive bids for a placement auction from owners of the on-chain blocks competing to incorporate respective on-chain blocks into the randomized event session. The server can evaluate the received bids according to preconfigured auction rules and select a subset of the on-chain blocks corresponding to highest and/or winning bids for incorporation into a current and/or future randomized event session.

In some implementations, the server may adjust a probability of success in the randomized event session according to the weighted values of the on-chain blocks (and/or the weighted values of the associated media data). The probability of success for a given on-chain block may be inversely proportional to the weighted value of the on-chain block and/or the media data of the on-chain block. For example, the server can compute a number of event positions allocated to each on-chain block by dividing a total number of available event positions by a normalization factor derived from the weighted values of all on-chain blocks incorporated into the randomized event session, and rounding the result to an integer value. An on-chain block having a higher weighted value can be allocated to a fewer number of event positions than an on-chain block having a lower weighted value, such that the selection probability for the higher-weighted-value on-chain block is lower than the selection probability for the lower-weighted-value on-chain block. For example, where a first image of a particular dog associated with a first on-chain block has a higher weighted value than a second image of a raven associated with a second on-chain block, the server may assign the first image of the dog to two event positions of a slot machine game session and/or a roulette game session, and may assign the second image of the raven to five event positions of the same session. The probability of winning the slot machine game session and/or the roulette game session with the first image of the dog may therefore be lower than the probability of winning the slot machine game session and/or the roulette game session with the second image of the raven.

In operation 230, the server receives a request to initiate the randomized event session. The server may receive the request from a session user device. A session user device may be a user device operated by an owner of the user device, and/or a shared computing device (e.g., a kiosk, a public terminal, a gaming machine on a casino floor, etc.) that is publicly available and operated by the same entity that operates the event host system (e.g., the event host system 101). The request may include a distributed address and/or account information (e.g., credit account information, bank account information, debit card information, etc.) of a user of the session user device, and an amount of risk to participate in the randomized event session. The amount of risk may be predetermined by the host device (e.g., the event host device 102) and/or selected by the user through the user interface (e.g., the user interface 114) rendered on the session user device.

The distributed address may be an address of a crypto wallet maintained by a blockchain control system (e.g., the blockchain control system 107) and/or a crypto wallet maintained by a different blockchain control system external to the randomized event system (e.g., the system 100). In some implementations, the host device may query the blockchain control system to verify whether the distributed address is valid, and whether sufficient funds (e.g., crypto-assets, fungible tokens, stablecoins, etc.) exist at the distributed address to satisfy the amount of risk. For example, the host device may transmit a balance verification request to the blockchain control device (e.g., the blockchain control device 108) that includes the distributed address and the amount of risk, and the blockchain control device may query the blockchain (e.g., the blockchain 150) to determine a current balance at the distributed address and return a verification response indicating whether the current balance is greater than and/or equal to the amount of risk. In some implementations, the host device may query a third-party device operated by a financial institution (e.g., a bank server, a credit card issuer server, a payment processor, etc.) to verify whether the user account is valid, and whether sufficient funds exist for the user account to satisfy the amount of risk. In some implementations, the request may include a user-selection in the randomized event session. For example, in a roulette game session, the user may select one or more event positions in the gameplay graphical user interface corresponding to a particular digital media and/or image of a block (e.g., an NFT) on which the user places a wager via the user interface rendered on the session user device.

In operation 240, the server selects an on-chain block according to a random value. In response to verifying that the user has sufficient funds to participate in the randomized event session, the server executes a randomization algorithm that randomly identifies and/or selects a block ID from a set of block IDs corresponding to available event positions in the randomized event session. For example, the randomization algorithm may generate one or more random values, where each random value corresponds to a respective event position and/or a respective block ID assigned to the event position. In some implementations, the randomization algorithm can generate a pseudo-random number using a seed value derived from a system clock timestamp, a hash of a prior transaction block on the distributed ledger, and/or a cryptographic nonce received from a blockchain control system (e.g., the blockchain control device 108). The server can map the generated random value to a block ID by indexing into an ordered set of block identifiers stored in a host database (e.g., the host database 104), where each index position in the ordered set corresponds to a respective event position of the randomized event session.

The server may determine the outcome of the randomized event session by evaluating whether the randomization algorithm generated a particular pattern and/or sequence of random values across multiple event positions. For example, in a slot machine game session, the server can determine that the user achieved a successful outcome when three identical random values are generated across three respective virtual reels of the slot machine game session, where each identical random value maps to the same block identifier and/or the same media data of an on-chain block. In some implementations, the server can evaluate additional pattern types beyond identical values, such as sequential random values that map to block identifiers having consecutively ordered weighted values, and/or random values that map to block identifiers belonging to a same media type category (e.g., animal image type, symbol image type, celebrity image type, etc.).

The server may determine the outcome of the randomized event session by comparing a random value generated by the randomization algorithm against an event position number of an image and/or an on-chain block selected by the user via the user interface (e.g., the user interface 114). For example, in a roulette game session, the server can determine that the user achieved a successful outcome when the random value generated by the randomization algorithm matches a pocket value and/or a pocket number associated with the image and/or the on-chain block that the user selected prior to execution of the randomization algorithm. The server can compare the generated random value against one or more user-selected event position numbers stored in a session state data structure maintained in the host database (e.g., the host database 104), and can generate a match indicator when the generated random value corresponds to at least one of the user-selected event position numbers.

In some embodiments, the operation 240 can be performed by the session user device and/or the shared public device rather than the server. For example, the session user device (e.g., the first user device 106a) can execute the randomization algorithm locally using event configuration information previously received from the server (e.g., the event host device 102), generate the random values, and determine the outcome of the randomized event session without transmitting intermediate requests to the server during execution of the randomization algorithm.

In operation 250, the server determines a first award value for a user account that initiated the randomized event session. The server determines the first award value for the user account associated with the session user device that participated in and/or initiated the randomized event session based on the on-chain blocks. The first award value may correspond to and/or may be proportional to the amount of risk included in the request from the session user device. The server may provide different amounts of award for a successful outcome in the randomized event session to the session user device, according to weighted values of the on-chain blocks and/or weighted values of media data associated with the on-chain blocks. In some implementations, the server may determine the amount of award for the successful outcome in the randomized event session according to the adjusted probability of success assigned to the randomly selected on-chain block. For example, the server may assign a larger amount of award when the user wins a slot machine game session and/or a roulette game session with an image having a lower probability of success, and may assign a smaller amount of award when the user wins the slot machine game session and/or the roulette game session with an image having a higher probability of success.

In some implementations, the server may determine the first award value by multiplying the amount of risk in the request by a coefficient that is inversely proportional to the probability of success for the corresponding on-chain block, such that an on-chain block allocated to fewer event positions (e.g., a lower selection probability) yields a larger first award value relative to the amount of risk than an on-chain block allocated to a greater number of event positions (e.g., a higher selection probability). In some implementations, the server may determine the first award value by multiplying the amount of risk in the request by the weighted value of the randomly selected on-chain block.

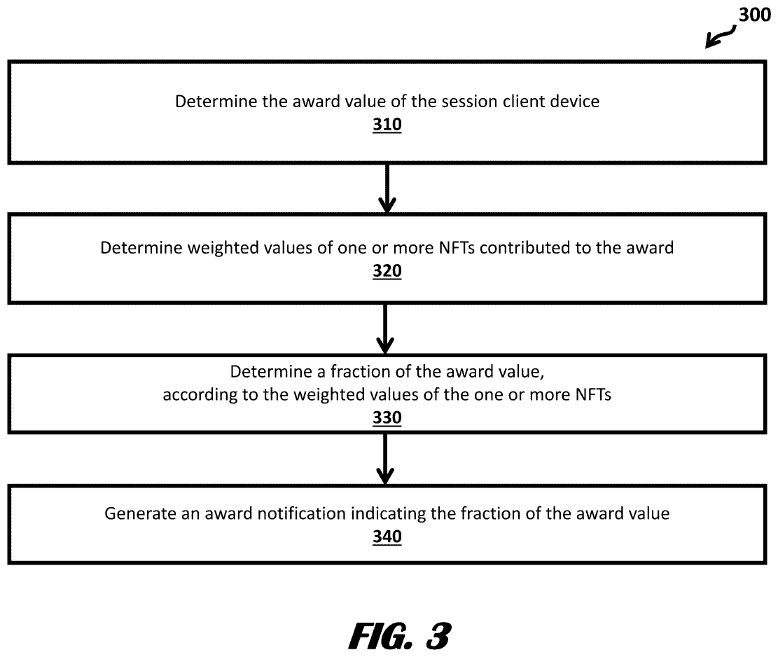

The server further determines a second award value for an owner of the on-chain block, according to the owner's user account information stored in a database (e.g., the host database 104). The server determines the second award value based upon a fraction of the first award value determined for the winning player. The fraction may be a predetermined percentage stored in the database in association with the on-chain block and/or a variable percentage that the server computes based on the weighted value of the on-chain block relative to weighted values of other on-chain blocks incorporated into the randomized event session. The server distributes the second award value to the owner(s) of the particular on-chain block(s) that contributed to the successful outcome in the randomized event session (as described below with respect to FIG. 3).

As an example, the server hosts a roulette game accessed by a user device (e.g., a personal computer, a gaming device in a casino, etc.), and executes the randomization algorithm to select a winning on-chain block from the on-chain blocks assigned to event positions of the roulette game session. The server determines whether a player-user entered inputs selecting the particular winning on-chain block and placing a related wager prior to execution of the randomization algorithm. If the player successfully selected the winning on-chain block, the server determines the first award value based on one or more criteria (e.g., amount wagered by the player, scarcity and/or likelihood that the winning on-chain block could be selected, the weighted value of the winning on-chain block, etc.). The server determines a second award value as a royalty and/or payout to the owner of the winning on-chain block, based on one or more criteria (e.g., a preconfigured fixed payout value, a market and/or purchase value of the on-chain block, the fraction of the first award value, etc.).

As an example, the server hosts a slots game accessed by the user device (e.g., a personal computer, a gaming device in a casino, etc.), and executes the randomization algorithm to select a set of selected on-chain blocks. The server incorporates a plurality of on-chain blocks into a set of wheels of a virtual slot machine, where each wheel includes the same plurality of on-chain blocks. The server assigns and/or determines a gaming-value associated with each particular on-chain block based upon one or more criteria (e.g., market and/or purchase value of the on-chain block, scarcity of the on-chain block, a random value, the weighted value of the on-chain block, etc.). For each wheel, the randomization algorithm randomly selects a selected on-chain block, and the server determines the player's score based upon the gaming-values of the selected on-chain blocks across the wheels. The server determines whether the player's score satisfies one or more winning thresholds that correspond to one or more payout amounts. In some implementations, where there is one winning threshold, the server determines that the player wins if the player's score satisfies the winning threshold.

In some implementations, where there are two or more winning thresholds, the server determines that the player-user wins if the player-user's score satisfies a first winning threshold and further determines the first award value according to the winning thresholds satisfied by the player's score. For example, a first winning threshold may correspond to a first payout amount, and a second winning threshold (e.g., higher than the first winning threshold) may correspond to a second payout amount greater than the first payout amount, and the server may assign the first award value to be the payout amount corresponding to the highest winning threshold satisfied by the player's score. In a competitive slots embodiment, the server selects a set of selected on-chain blocks for each of the player-users participating in the session. The server identifies the winning player by comparing each player's score, where the winning player received the comparatively better player score according to preconfigured comparative scoring rules (e.g., highest cumulative gaming-value, highest single-wheel gaming-value, closest gaming-value to a target value).

If the player-user won and/or satisfied a particular winning threshold, the server determines a second award value as a royalty and/or payout to the owner of the selected on-chain block based on one or more criteria (e.g., a preconfigured fixed payout value, a market and/or purchase value of the on-chain block, the fraction of the first award value, etc.). In some implementations, the player may win even when the randomization algorithm selected different on-chain blocks across the respective wheels. In such implementations, the server determines respective award values as royalties and/or payouts to each owner of the selected on-chain blocks based on the one or more criteria. For example, where three different on-chain blocks owned by three different owners are selected across three wheels of the virtual slot machine for a winning player, the server may compute three respective second award values, each based on the weighted value of the corresponding on-chain block and/or the fraction of the first award value assigned to the corresponding on-chain block, and the server may generate a separate award notification for each of the three owners.

In operation 260, the server generates a first award notification indicating the first award value. The server can execute the executable program that is on-chain and/or separate software programming to identify a payment account associated with the user account that initiated the randomized event session, where the payment account may be maintained by a blockchain control system (e.g., the blockchain control system 107) and/or a third-party device operated by a financial institution (e.g., a bank server, a credit card issuer server, a payment processor, etc.). The server may include or access a database (e.g., the host database 104) that stores, for different user accounts, corresponding payment accounts. The server may retrieve, from the database, the payment account associated with the user account by querying the database with a user account identifier included in the request received in operation 230.

In some implementations, where the payment account for the user account is not available and/or is invalid (e.g., expired, revoked, associated with a closed account, etc.), the server may transmit an instruction to the user device associated with the user account to generate a user interface that prompts the user to input payment account information. For example, the server can transmit a payment account request message to the user device (e.g., the user device 106), and the user device can render an input form on the user interface (e.g., the user interface 114) containing fields for a distributed address of a crypto wallet, a bank routing number, an account number, and/or a card token, and the server can receive the input payment account information from the user device and store the received payment account information in the database in association with the user account identifier. The server generates the first award notification authorizing payment of the first award value to the identified payment account. The server may transmit the first award notification to the blockchain control system (e.g., the blockchain control system 107) and/or the third-party device operated by the financial institution associated with the payment account to authorize payment of the first award value to the payment account associated with the user account.

The server may generate award notifications indicating second award values for user accounts associated with owners of winning on-chain blocks that were selected and/or contributed to a successful outcome in the randomized event session. For each user account associated with an owner-user of one or more on-chain blocks that were selected and/or contributed to the successful outcome, the server can execute the executable program that is on-chain and/or separate software programming to identify a payment account of the blockchain control system (e.g., the blockchain control system 107) and/or a third-party device operated by a financial institution (e.g., a bank server, a credit card issuer server, a payment processor, etc.) from the database (e.g., the host database 104). For example, the server can query the database with the user account identifier of the owner associated with a given on-chain block, retrieve a corresponding distributed address of a crypto wallet and/or a fiat-currency payment account identifier stored in association with the user account identifier, and populate a second award notification data structure with the retrieved payment account identifier and the second award value computed for the corresponding on-chain block. For each user account associated with an owner of one or more on-chain blocks that were selected and/or contributed to the successful outcome, the server generates a corresponding award notification authorizing payment of the second award value to the identified payment account.

The server may transmit, for each such user account, the award notification to the blockchain control system and/or the third-party device associated with the corresponding payment account to authorize payment of the second award value to the payment account associated with the user account. In some implementations, where multiple on-chain blocks owned by different owners contributed to the successful outcome (e.g., three different on-chain blocks displayed along a pay line of a slot machine game session, multiple on-chain blocks selected across wheels of a competitive slots session, etc.), the server can generate a separate award notification for each owner, where each award notification includes a respective second award value computed based on the weighted value of the corresponding on-chain block and/or the fraction of the first award value assigned to the corresponding on-chain block as determined in operation 250.

In some implementations, the award notification includes or is accompanied by an instruction that causes a receiving computing device (e.g., service provider server 113) to update one or more user information databases associated with the owner of the selected on-chain block. The receiving computing device may be associated with, for example, a blockchain control system, bank server, casino management server, payment processor, gaming platform server, or other account management system. The instruction may cause the receiving computing device to identify a user account record corresponding to the owner, verify that the owner is eligible to receive the second award value, and update one or more fields of the user account record according to the second award value. For example, the instruction may cause the receiving computing device to increase a stored account balance, record a pending payment, update a rewards account, update a casino credit account, update a wallet account, or store an audit record linking the account update to the selected on-chain block and the randomized event session.

FIG. 3 is a flowchart depicting operations of a method 300 for distributing award values to user accounts associated with owners of winning on-chain blocks whose media data was selected and/or contributed to a successful outcome in a randomized event session, according to embodiments. Embodiments may include additional, fewer, and/or different operations than those described in the method 300. The method 300 can be performed by a server (e.g., an event host device 102 of the event host system 101) executing machine-readable software code associated with a distributed ledger ecosystem of participating nodes, though one or more computing devices and/or processors may perform the various operations described in FIG. 3. In some implementations, one or more steps of the method 300 can be performed by a user device (e.g., a user device 106) that receives event configuration information and/or award determination parameters from the server, and executes the award distribution operations locally based on the received parameters. In some implementations, one or more steps of the method 300 can be performed by a blockchain control device (e.g., the blockchain control device 108) that executes an on-chain executable program to compute fractional award values and generate corresponding transaction data on the distributed ledger (e.g., the blockchain 150) without routing the computation through the server.

In operation 310, the server determines the first award value of the session user device. The first award value may be an award corresponding to a successful outcome in a randomized event session incorporating one or more on-chain blocks. In some implementations, the first award value corresponds to the award value determined in operation 250 of FIG. 2 (e.g., as determined based on the amount of risk in the request from the session user device, the weighted value of the randomly selected on-chain block, and/or the adjusted probability of success assigned to the randomly selected on-chain block). For example, the server can retrieve the first award value from a session state data structure stored in a host database (e.g., the host database 104) by querying the session state data structure with a session identifier corresponding to the randomized event session and a user account identifier corresponding to the session user device.

In operation 320, the server determines a weighted value of an on-chain block that contributed to the award. The on-chain blocks that contributed to the award may be one or more on-chain blocks whose media data was randomly selected to produce the successful outcome in the randomized event session. A weighted value of an on-chain block may correspond to and/or may be proportional to the market value of the on-chain block traded on a public market platform (e.g., Rarible, NFT stars, Crypto. com, VeVe, etc.). In some implementations, the server assigns a weighted value for an on-chain block according to a number of other on-chain blocks having the same media data, a currency value, a third-party value received from a third-party device (e.g., an external value feed computing device such as the blockchain oracle server 111), and/or any combination of them. For each on-chain block, the server may query a blockchain control system (e.g., the blockchain control system 107), an external value feed computing device (e.g., the blockchain oracle server 111), and/or a public market platform (e.g., Rarible, NFT stars, Crypto. com, VeVe, etc.), and determine the weighted value of the on-chain block to be proportional to the last traded market value of the on-chain block, and/or an average market value of the on-chain block over a predetermined time period (e.g., 6 months, 12 months, etc.). In some implementations, the server may determine a type of digital media of the on-chain block and assign a corresponding value for the determined type as the weighted value of the on-chain block. For example, types of digital media can include image data type, video data type, and/or audio data type, and the types of digital media may be categorized according to subject and/or content in the digital media data (e.g., animal image type, symbol image type, automobile image type, celebrity image type, cartoon image type, etc.). The server may determine the weighted value of the on-chain block to be proportional to an average market value of on-chain blocks owned by the same owner and/or associated with the same distributed address of a crypto wallet.

In operation 330, the server determines a fraction of the first award value for a user account associated with the on-chain block, according to the weighted value of the on-chain block. In some implementations, the server multiplies the first award value of the session user device determined in operation 310 by a coefficient that is proportional to the weighted value of the on-chain block determined in operation 320. For example, the server can retrieve the weighted value of the on-chain block from a host database (e.g., the host database 104), compute a ratio of the weighted value of the on-chain block to a sum of weighted values of all on-chain blocks incorporated into the randomized event session, and multiply the first award value by the computed ratio to generate the fractional award value for the owner of the on-chain block. In some implementations, different on-chain blocks may have different fractions of the first award value, according to the corresponding weighted values of the respective on-chain blocks. For example, where a first on-chain block has a weighted value of one-hundred (100) units and a second on-chain block has a weighted value of two-hundred (200) units, the server can compute a first fractional coefficient for the first on-chain block and a second fractional coefficient for the second on-chain block, where the second fractional coefficient is greater than the first fractional coefficient in proportion to the respective weighted values.

In operation 340, the server generates an award notification indicating the fraction of the first award value. For the user account associated with an owner of the on-chain block that was selected and/or contributed to the successful outcome in the randomized event session, the server identifies a payment account maintained by a blockchain control system (e.g., the blockchain control system 107) and/or a third-party device operated by a financial institution (e.g., a bank server, a credit card issuer server, a payment processor, etc.) from a database (e.g., the host database 104). For example, the server can query the database with the user account identifier of the owner associated with the on-chain block, retrieve a corresponding distributed address of a crypto wallet and/or a fiat-currency payment account identifier stored in association with the user account identifier, and populate the award notification data structure with the retrieved payment account identifier and the fractional award value computed in operation 330.

The server generates the award notification authorizing payment of the fractional award value to the identified payment account. The server may transmit the award notification to the blockchain control system (e.g., the blockchain control system 107) and/or the third-party device operated by the financial institution associated with the payment account to authorize payment of the fractional award value to the payment account associated with the user account of the owner. In some implementations, where multiple on-chain blocks owned by different owners contributed to the successful outcome (e.g., three different on-chain blocks displayed along a pay line of a slot machine game session, multiple on-chain blocks selected across wheels of a competitive slots session, etc.), the server can generate a separate award notification for each owner, where each award notification includes a respective fractional award value computed based on the weighted value of the corresponding on-chain block as determined in operation 320 and the fractional coefficient computed in operation 330.

In some implementations, the award notification generated in operation 340 includes a machine-readable instruction configured to update account information for the owner of the on-chain block in a user information database, which may include a user database of a payment server among any number of other types of computing devices and databases that process and store user related data fields for player-users or owner-users (or possessor-users). The instruction may specify the second award value, an owner user account identifier, an account database identifier, a payment account identifier, the token identifier or block identifier of the on-chain block, and a session identifier for the randomized event session. The server may transmit the instruction to a receiving computing device that maintains or controls access to the user database. In response to the instruction, the receiving computing device may modify a stored account record for the owner, create a new transaction history entry, update a pending-payment status, or generate a confirmation message indicating that the user database was updated. The server may store the confirmation message in the host database 104 or use the confirmation message to update session state data for the randomized event session.

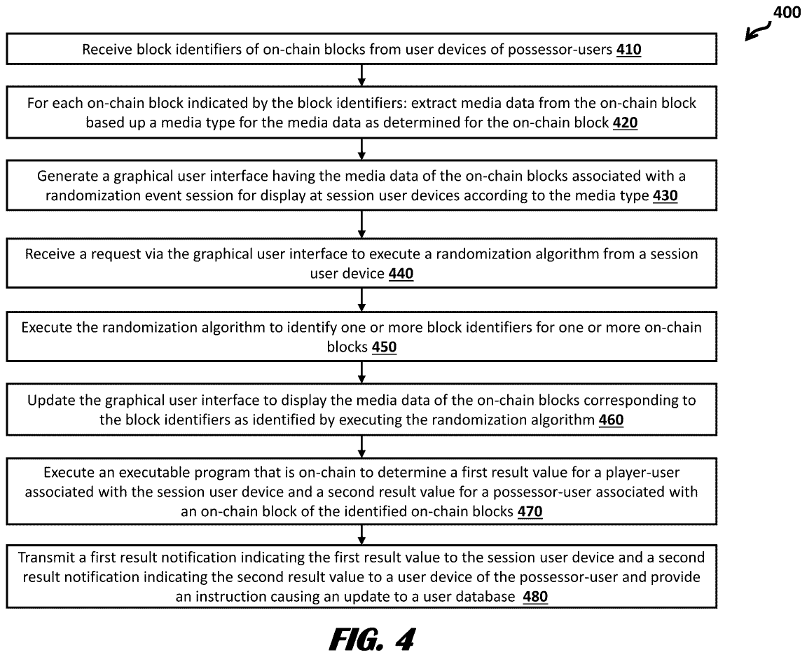

FIG. 4 is a flowchart depicting operations of a computer-implemented method 400 for identifying and extracting media data from on-chain blocks, according to embodiments. Embodiments may include additional, fewer, and/or different operations than those described in the method 400. The method 400 can be performed by a computer (e.g., an event host device 102 of the event host system 101) executing machine-readable software code, though one or more computing devices and/or processors may perform the various operations described in FIG. 4. In some implementations, one or more operations of the method 400 can be performed by a user device (e.g., a user device 106) that receives event configuration information from the computer and executes one or more of the operations locally according to the event configuration information.

At operation 410, the computer receives a plurality of block identifiers of a plurality of on-chain blocks from one or more user devices of one or more owner-users (sometimes referred to as possessor-users). Each on-chain block may be identified by a unique block identifier (e.g., a unique token identifier, a content hash, a minting transaction identifier, etc.). In some implementations, the computer can receive the plurality of block identifiers together with a permission indication from each of the one or more user devices, where the permission indication authorizes the computer to incorporate media data of the corresponding on-chain blocks into one or more randomization event sessions. For example, the computer can receive, from a first user device of a first possessor-user, a set of block identifiers and a binary authorization flag indicating that the first possessor-user grants the computer access to extract and display media data of the on-chain blocks referenced by the set of block identifiers.

At operation 420, for each on-chain block indicated by each of the plurality of block identifiers, the computer extracts media data from the on-chain block based on a media type for the media data as determined by the computer for the on-chain block. The computer can determine the media type at runtime based on characteristics of the retrieved data, such as file headers, data structures, and/or metadata embedded within the media data. In some implementations, the computer can determine a storage format type for each on-chain block and execute a corresponding retrieval operation to extract the media data based on the determined storage format type. For example, where the computer determines that the on-chain block contains the media data embedded directly within an on-chain data structure, the computer can parse the on-chain data structure to extract the media data without transmitting a retrieval request to an external storage location. As another example, where the computer determines that the on-chain block includes a content identifier referencing a distributed storage node containing the media data according to a distributed storage protocol (e.g., IPFS), the computer can resolve the content identifier and retrieve the media data from the distributed storage node indicated by the content identifier. As another example, where the computer determines that the on-chain block includes a uniform resource locator referencing a storage media location containing the media data, the computer can transmit a network request to the storage media location indicated by the uniform resource locator to fetch the media data.

After extraction and/or retrieval of the media data, the computer can convert the media data into a display-ready format compatible with a graphical user interface for incorporation into the graphical user interface during a randomization event session.

At operation 430, the computer generates a graphical user interface having the media data of the plurality of on-chain blocks associated with a randomization event session for display at one or more session user devices of one or more player-users according to the media type of the media data. In some implementations, the computer can classify the media data of each on-chain block into one or more media type categories, such as a static image type, an animated image type, a video type, and/or an audio type, and can configure corresponding graphical elements of the graphical user interface to present the media data according to the determined media type category. For example, for media data classified as a static image type, the computer can render the image data within a display element of the graphical user interface at a resolution and aspect ratio corresponding to dimensions of the graphical element, and for media data classified as a video type, the computer can configure playback timing and frame rates appropriate for the video format such that the video data plays within the graphical element during the randomization event session. In some implementations, the graphical user interface can include one or more virtual reels of a virtual slot machine, one or more positions of a virtual roulette wheel, and/or one or more lottery ticket display areas, where each graphical element displays extracted media data of a respective on-chain block assigned to the corresponding event position.

At operation 440, the computer receives a request via the graphical user interface to execute a randomization algorithm from a session user device. In some implementations, the request can include a distributed address of a crypto wallet (e.g., a crypto wallet 120) associated with a player-user of the session user device, and/or an amount of risk to participate in the randomization event session. For example, the session user device can transmit the request containing the distributed address and a wager amount selected by the player-user via the graphical user interface, and the computer can verify that sufficient funds exist at the distributed address to satisfy the wager amount prior to executing the randomization algorithm.

At operation 450, the computer executes the randomization algorithm to identify one or more block identifiers corresponding to one or more on-chain blocks. The randomization algorithm can generate one or more random values, where each random value corresponds to a respective event position and/or a respective block identifier assigned to the event position in the graphical user interface. For example, in a slot machine game session, the randomization algorithm can generate a random value for each virtual reel of the virtual slot machine, and the computer can map each generated random value to a block identifier by indexing into an ordered set of block identifiers stored in a database (e.g., the host database 104), where each index position in the ordered set corresponds to a respective event position of the randomization event session. In some implementations, the computer can execute the randomization algorithm according to weighted values assigned to each on-chain block, where a probability of selection for each on-chain block in the randomization algorithm is inversely proportional to the weighted value of the on-chain block.

At operation 460, the computer updates the graphical user interface to display the media data of the one or more on-chain blocks corresponding to the one or more block identifiers as identified by executing the randomization algorithm. The computer can generate a synchronization signal that triggers the graphical user interface to replace a current set of displayed media data with media data of the on-chain blocks corresponding to the randomization output. For example, the computer can generate the synchronization signal as a display update instruction containing the block identifiers of the randomly selected on-chain blocks and/or references to display-ready media data stored in the database (e.g., the host database 104) for each randomly selected on-chain block, and can transmit the display update instruction to the session user device rendering the graphical user interface. In some implementations, the computer can verify that visual elements rendered on the graphical user interface correspond to the randomization output by comparing the block identifiers associated with the displayed visual elements against the block identifiers indicated in the randomization output, and can regenerate the graphical user interface using the media data corresponding to the randomization output upon detecting a discrepancy.

At operation 470, the computer determines, by executing an executable program that is on-chain (e.g., a smart contract stored on a blockchain such as the blockchain 150), a first result value (sometimes referred to as an award value, such as a first award value) for a player-user associated with the session user device and a second result value (sometimes referred to as an award value, such as a second award value) for a possessor-user associated with an on-chain block of the one or more on-chain blocks. The first result value may correspond to and/or may be proportional to the amount of risk included in the request received at operation 440. In some implementations, the computer can determine the first result value by multiplying the amount of risk by a coefficient that is inversely proportional to the probability of selection for the corresponding on-chain block, such that an on-chain block allocated to fewer event positions yields a larger first result value relative to the amount of risk than an on-chain block allocated to a greater number of event positions. The second result value can be based upon a fraction of the first result value. For example, the executable program that is on-chain can compute the second result value by multiplying the first result value by a fractional coefficient stored in a database (e.g., the host database 104) in association with the block identifier of the on-chain block, where the fractional coefficient can be a fixed percentage value and/or a variable value that the computer computes based on a weighted value of the on-chain block relative to weighted values of other on-chain blocks incorporated into the randomization event session.

At operation 480, the computer transmits a first result notification indicating the first result value to the session user device and a second result notification indicating the second result value to a user device of the possessor-user and provides an instruction causing an update to a user information database, for example, a payment server among any number of other types of computing devices and databases that process and store user related data fields for player-users or owner-users (or possessor-users). The computer can identify a payment account associated with the player-user by querying a database (e.g., the host database 104) with a user account identifier of the player-user, and can populate the first result notification with the first result value and a payment account identifier of the player-user. The computer can identify a payment account associated with the possessor-user by querying the database with a user account identifier of the possessor-user associated with the on-chain block, and can populate the second result notification with the second result value and a payment account identifier of the possessor-user. The computer can also generate the instruction based on the second result value, an account identifier associated with the possessor-user, and the on-chain block that contributed to the randomization outcome.

In some implementations, the instruction causing the update to the user database can include a database update command, an API request, a transaction request, a signed payment authorization, a smart-contract event payload, or another machine-readable instruction set executable or processable by a receiving computing device. The receiving computing device may include a blockchain control system (e.g., the blockchain control system 107), a third-party device operated by a financial institution, a bank server, a casino management system, a payment processor, a gaming platform server, or another account management system. The user database may store account information including, for example, a balance value, pending-payment field, rewards value, casino credit value, transaction history field, wallet balance, or audit record associated with the possessor-user. In response to the instruction, the receiving computing device can update the user database according to the second result value and can transmit a confirmation message to the computer indicating that the user database was updated. In some implementations, the computer can transmit the first result notification as a transaction request data structure containing the distributed address of the player-user's crypto wallet (e.g., a crypto wallet 120) and the first result value denominated in a crypto-asset unit, and can transmit the second result notification and the instruction as one or more data structures containing the possessor-user's account identifier, the second result value, and the block identifier of the on-chain block associated with the possessor-user. In some cases, the computer may transmit the second result notification as a transaction request data structure or instruction containing the distributed address of the possessor-user's crypto wallet (e.g., a crypto wallet 120) and the second result value as a fiat currency, crypto currency, or other crypto-asset unit.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for identifying and extracting media data from on-chain blocks, the method comprising:
receiving, by a computer, a plurality of block identifiers of a plurality of on-chain blocks from one or more user devices of one or more possessor-users;
for each on-chain block indicated by each of the plurality of block identifiers:
extracting, by the computer, media data from the on-chain block based on a media type for the media data as determined by the computer for the on-chain block;
generating, by the computer, a graphical user interface having the media data of the plurality of on-chain blocks associated with a randomization event session for display at one or more session user devices of one or more player-users according to the media type of the media data;
receiving, by the computer, a request via the graphical user interface to execute a randomization algorithm from a session user device;
executing, by the computer, the randomization algorithm to identify one or more block identifiers corresponding to one or more on-chain blocks;
updating, by the computer, the graphical user interface to display the media data of the one or more on-chain blocks corresponding to the one or more block identifiers as identified by executing the randomization algorithm;
determining, by the computer executing an executable program that is on-chain, a first result value for a player-user associated with the session user device and a second result value for a possessor-user associated with an on-chain block of the one or more on-chain blocks; and
transmitting, by the computer, a first result notification indicating the first result value to the session user device and a second result notification indicating the second result value to a user device of the possessor-user and providing an instruction causing an update to a user database.

2. The computer-implemented method of claim 1, wherein the computer determines that the on-chain block contains the media data in a data structure of the on-chain block, and wherein the computer parses the data structure to obtain the media data of the on-chain block.

3. The computer-implemented method of claim 1, wherein the computer determines that the on-chain block includes a content identifier referencing a distributed storage node containing the media data according to a distributed storage protocol, and wherein the computer retrieves the media data from the distributed storage node indicated by the content identifier.

4. The computer-implemented method of claim 1, wherein the computer determines that the on-chain block includes a uniform resource locator referencing a storage media location containing the media data, and wherein the computer retrieves the media data from the storage media location indicated by the uniform resource locator.

5. The computer-implemented method of claim 1, wherein the media type includes at least one of a static image type, an animated image type, a video type, or an audio type.

6. The computer-implemented method of claim 1, further comprising: determining, by the computer, a weighted value assigned to each on-chain block, wherein the computer executes the randomization algorithm according to the weighted value assigned to the on-chain block.

7. The computer-implemented method of claim 6, wherein the weighted value assigned to each on-chain block indicates at least one of: a number of other on-chain blocks having the media data, an exchange value, and a third-party value received from an external value feed computing device.

8. The computer-implemented method of claim 6, further comprising: adjusting, by the computer, a probability of selection for each on-chain block in the randomization algorithm, wherein the probability of selection is inversely proportional to the weighted value of the on-chain block.

9. The computer-implemented method of claim 1, further comprising:
updating, by the computer executing a second executable program that is on-chain, an on-chain operational event block to indicate the on-chain block of the possessor-user is transferred from a first distributed address associated with the possessor-user to a second distributed address accessible to the computer,
wherein the computer generates the graphical user interface for the randomization event session using the on-chain block associated with the second distributed address.

10. The computer-implemented method of claim 9, further comprising:
updating, by the computer executing the second executable program that is on-chain, a second on-chain operational event block to indicate the on-chain block is transferred from the second distributed address to the first distributed address in response to a triggering condition identified by the computer,
wherein the triggering condition comprises at least one of an expiration of a predetermined session duration or receipt of a session termination instruction.

11. The computer-implemented method of claim 1, wherein the request received from the session user device includes an amount of risk for the randomization event session.

12. A system for identifying and extracting media data from on-chain blocks, the system comprising:
a computer comprising a processor, configured to:
receive a plurality of block identifiers of a plurality of on-chain blocks from one or more user devices of one or more possessor-users;
for each on-chain block indicated by each of the plurality of block identifiers:
extract media data from the on-chain block based on a media type for the media data as determined for the on-chain block;
generate a graphical user interface having the media data of the plurality of on-chain blocks associated with a randomization event session for display at one or more session user devices of one or more player-users according to the media type of the media data;
receive a request via the graphical user interface to execute a randomization algorithm from a session user device;
execute the randomization algorithm to identify one or more block identifiers corresponding to one or more on-chain blocks;
update the graphical user interface to display the media data of the one or more on-chain blocks corresponding to the one or more block identifiers as identified by executing the randomization algorithm;
determine, by executing an executable program that is on-chain, a first result value for a player-user associated with the session user device and a second result value for a possessor-user associated with an on-chain block of the one or more on-chain blocks; and
transmit a first result notification indicating the first result value to the session user device and a second result notification indicating the second result value to a user device of the possessor-user and providing an instruction causing an update to a user database.

13. The system of claim 12, wherein the computer is further configured to determine that the on-chain block contains the media data in a data structure of the on-chain block, and to parse the data structure to obtain the media data of the on-chain block.

14. The system of claim 12, wherein the computer is further configured to determine that the on-chain block includes a content identifier referencing a distributed storage node containing the media data according to a distributed storage protocol, and to retrieve the media data from the distributed storage node indicated by the content identifier.

15. The system of claim 12, wherein the computer is further configured to determine that the on-chain block includes a uniform resource locator referencing a storage media location containing the media data, and to retrieve the media data from the storage media location indicated by the uniform resource locator.

16. The system of claim 12, wherein the computer is further configured to determine a weighted value assigned to each on-chain block, wherein the system executes the randomization algorithm according to the weighted value assigned to the on-chain block.

17. The system of claim 16, wherein the computer is further configured to adjust a probability of selection for each on-chain block in the randomization algorithm, wherein the probability of selection is inversely proportional to the weighted value of the on-chain block.

18. The system of claim 12, wherein the computer is further configured to:
update, by executing a second executable program that is on-chain, an on-chain operational event block to indicate the on-chain block of the possessor-user is transferred from a first distributed address associated with the possessor-user to a second distributed address accessible to the system,
wherein the computer generates the graphical user interface for the randomization event session using the on-chain block associated with the second distributed address.

19. The system of claim 18, wherein the computer is further configured to:
update, by executing the second executable program that is on-chain, a second on-chain operational event block to indicate the on-chain block is transferred from the second distributed address to the first distributed address in response to a triggering condition,
wherein the triggering condition comprises at least one of an expiration of a predetermined session duration or receipt of a session termination instruction.

20. A non-transitory machine-readable storage medium storing machine-executable instructions for identifying and extracting media data from on-chain blocks that, when executed by one or more processors, cause the one or more processors to:
receive a plurality of block identifiers of a plurality of on-chain blocks from one or more user devices of one or more possessor-users;
for each on-chain block indicated by each of the plurality of block identifiers:
extract media data from the on-chain block based on a media type for the media data as determined for the on-chain block;
generate a graphical user interface having the media data of the plurality of on-chain blocks associated with a randomization event session for display at one or more session user devices of one or more player-users according to the media type of the media data;
receive a request via the graphical user interface to execute a randomization algorithm from a session user device;
execute the randomization algorithm to identify one or more block identifiers corresponding to one or more on-chain blocks;
update the graphical user interface to display the media data of the one or more on-chain blocks corresponding to the one or more block identifiers as identified by executing the randomization algorithm;
determine, by executing an executable program that is on-chain, a first result value for a player-user associated with the session user device and a second result value for a possessor-user associated with an on-chain block of the one or more on-chain blocks; and
transmit a first result notification indicating the first result value to the session user device and a second result notification indicating the second result value to a user device of the possessor-user and providing an instruction causing an update to a user database.
